(19) United States
(12) Patent Application Publication
(10) Pub. No.: US 2014/0233362 A1
(43) Pub. Date: Aug. 21, 2014

(54) INFORMATION DEVICE

(71) Applicant: Panasonic Corporation, Osaka (JP)

(72) Inventors: Kenji Kondo, Osaka (JP); Kenji Fujiune, Osaka (JP); Takeharu Yamamoto, Osaka (JP)

(21) Appl. No.: 14/130,092

(22) PCT Filed: Oct. 16, 2012
(86) PCT No.: PCT/JP2012/006605

§ 371 Date: Dec. 30, 2013

(30) Foreign Application Priority Data
Oct. 21, 2011 (JP) 2011-231396

(51) Int. Cl. G11B 5/596

(52) U.S. Cl. CPC G11B 5/596
USPC 369/13.33; 360/77.02; 360/77.06

(57) ABSTRACT

An information device includes a slider (100) including a first metal antenna (103a), a second metal antenna (103b), and a heater (107) configured to vary the distance between the first metal antenna (103a) and the second metal antenna (103b) in a direction orthogonal to a track direction on the surface of a disk (104), and an arm motor (120) configured to move the slider (100) in parallel to the surface of the disk (104). The arm motor (120) and the heater (107) cause the first metal antenna (103a) and the second metal antenna (103b) to respectively follow corresponding target tracks.

### TECHNICAL FIELD

The present invention relates to an information device that records information on an information carrier or reproduces information from the information carrier.

### BACKGROUND ART

At present, storages such as a hard disk device are widely used for storage of information in various information devices.

In the hard disk device, the configuration of Patent Literature 1 is proposed to improve readout speed or writing speed of information.

In Patent Literature 1, a readout element and a writing element are formed as a set of magnetic elements. Two sets of magnetic elements are mounted on one slider.

The distance between the two sets of magnetic elements is set to integer times of track width on a magnetic disk, which is a recording medium. The configuration explained above enables readout or writing of information simultaneously for tracks in two or more places using the one slider. It is possible to realize improvement of readout speed or writing speed of information in the hard disk device.

On the other hand, in recent years, a method of realizing a further increase in the capacity of a storage and a hard disk device have been developed. In the hard disk device, in order to increase the storage capacity of the hard disk device, a storage capacity per one magnetic disk in use only has to be increased.

Information is recorded in the magnetic disk along concentric tracks. Therefore, it is possible to increase the storage capacity of the magnetic disk by improving density for recording per one round of the magnetic disk or reducing the width of the tracks to increase the number of tracks per one magnetic disk.

However, for example, in the hard disk device or the like in which a plurality of elements are mounted on one slider, when the track width is reduced to aim at an increase in a storage capacity, since it is necessary to improve following accuracy of the respective elements following the respective tracks, it is necessary to highly accurately determine the distance among the elements. Therefore, an increase in machining steps or adjustment steps for various components such as the slider is caused. As a result, a problem occurs in that costs of the device increase.

### CITATION LIST

### Patent Literature

Patent Literature 1: Japanese Patent Application Laid-open No. H1-116921

### SUMMARY OF THE INVENTION

The present invention has been devised in order to solve the problem and it is an object of the present invention to provide an information device that can cause respective elements on a head to respectively accurately follow target tracks on an information carrier and can improve recording performance and reproducing performance.

An information device according to an aspect of the present invention includes: a head including a first element, a second element, and an inter-element distance varying unit configured to vary the distance between the first element and the second element in a direction orthogonal to a track direction on the surface of the information carrier; and a head moving unit configured to move the head in parallel to the surface of the information carrier. The head moving unit and the inter-element distance varying unit cause the first element and the second element to respectively follow corresponding target tracks.

According to the present invention, the first element and the second element are caused to respectively follow corresponding target tracks by the head moving unit and the inter-element distance varying unit. Therefore, it is possible to cause the respective elements on the head to respectively accurately follow the corresponding target tracks on the information carrier. Further, it is possible to improve recording performance and reproducing performance.

Objects, characteristics, and advantages of the present invention are made clearer by the following detailed explanation and the accompanying drawings.

### BRIEF DESCRIPTION OF THE DRAWINGS

FIG. 1 is a block diagram showing the configuration of an information recording and reproducing device in a first embodiment of the present invention.

FIG. 2 is a top view showing an example of the configuration of a slider in FIG. 1.

FIG. 3 is a side view showing an example of the configuration of the slider in FIG. 1.

FIG. 4 is a block diagram showing the configurations of a first track positional deviation detecting unit and a second track positional deviation detecting unit in FIG. 1.

FIG. 5 is a diagram showing an example of arrays of cells on tracks on a disk and signals obtained by a light receiving element.

FIG. 6 is a schematic diagram showing the configuration of a slider in an information recording and reproducing device in a first modification of the first embodiment.

FIG. 7 is a schematic diagram showing the configuration of a slider in an information recording and reproducing device in a second modification of the first embodiment.

FIG. 8 is a schematic diagram showing the configuration of a slider in an information recording and reproducing device in a third modification of the first embodiment.

FIG. 9 is a block diagram showing the configuration of an information recording and reproducing device in a second embodiment of the present invention.

FIG. 10 is a schematic diagram showing an example of the configuration of a slider in FIG. 9.

FIG. 11 is a block diagram showing the configuration of an information recording and reproducing device in a first modification of the second embodiment.

FIG. 12 is a schematic diagram showing the configuration of a slider in an information recording and reproducing device in a second modification of the second embodiment.

FIG. 13 is a block diagram showing the configuration of an information recording and reproducing device in a third embodiment of the present invention.

FIG. 14 is a top view showing a state in which a slider is driven in a disk radial direction in the third embodiment.

FIG. 15 is a schematic diagram showing a relation among the slider, a first metal antenna, a second metal antenna, and tracks of the disk at the time when the slider is located near the outermost circumference of the disk.

FIG. 16 is a schematic diagram showing a relation among the slider, the first metal antenna, the second metal antenna, and the tracks of the disk at the time when the slider is located near the innermost circumference of the disk.

FIG. 17 is a block diagram showing the configuration of an information recording and reproducing device in a fourth embodiment of the present invention.

FIG. 18 is a schematic diagram showing an example of the configuration of a slider in FIG. 17.

FIG. 19 is a block diagram showing the configuration of an information recording and reproducing device in a fifth embodiment of the present invention.

FIG. 20 is a block diagram showing the configuration of a magnetic recording device in a sixth embodiment of the present invention.

FIG. 21 is a schematic diagram showing an example of the configuration of a slider in FIG. 20.

### DESCRIPTION OF EMBODIMENTS

Embodiments of the present invention are explained below with reference to the drawings. Note that the embodiments explained below are embodied examples of the present invention and do not limit the technical scope of the present invention.

An information device in each of the embodiments includes a head configured to move on the surface of an information carrier. Tracks are formed along a track direction on the surface of the information carrier. The information device includes a first element, a second element, a head including an inter-element distance varying unit configured to vary the distance between the first element and the second element in a direction orthogonal to the track direction on the surface of the information carrier, and a head moving unit configured to move the head in parallel to the surface of the information carrier. The head moving unit and the inter-element distance varying unit cause the first element and the second element to respectively follow corresponding target tracks.

With the configuration explained above, even when there is a component error or an assembly error in the information device, it is possible to cause the respective elements on the head to respectively accurately follow target tracks on the information carrier and improve recording performance and reproducing performance.

### First Embodiment

In a first embodiment, an information recording and reproducing device is explained as an example of the information device. A disk is explained as an example of the information carrier. A recording element for recording information on the information carrier is explained as an example of the first element. A reproducing element for reproducing the information from the information carrier is explained as an example of the second element.

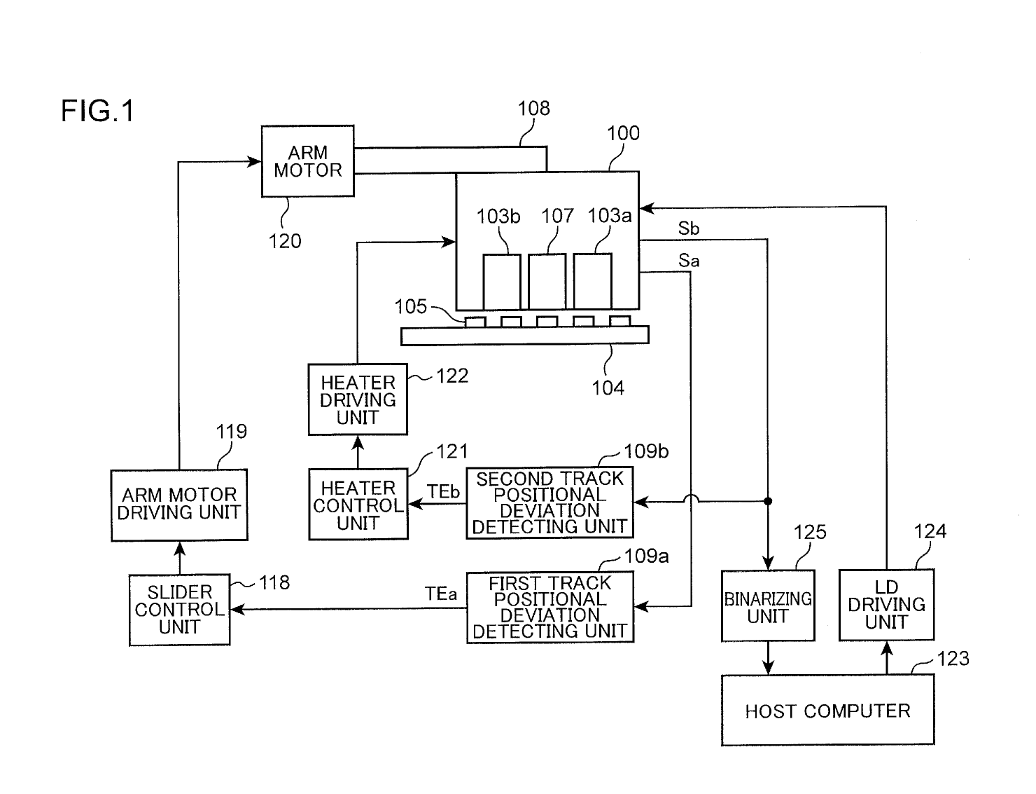

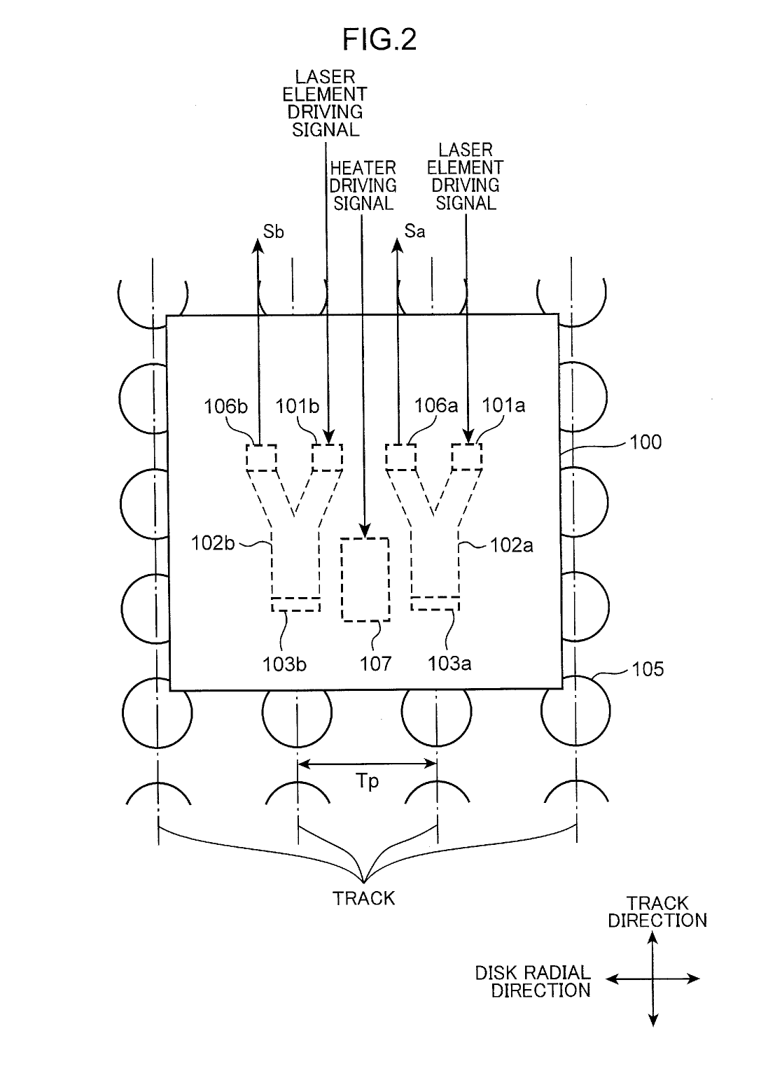

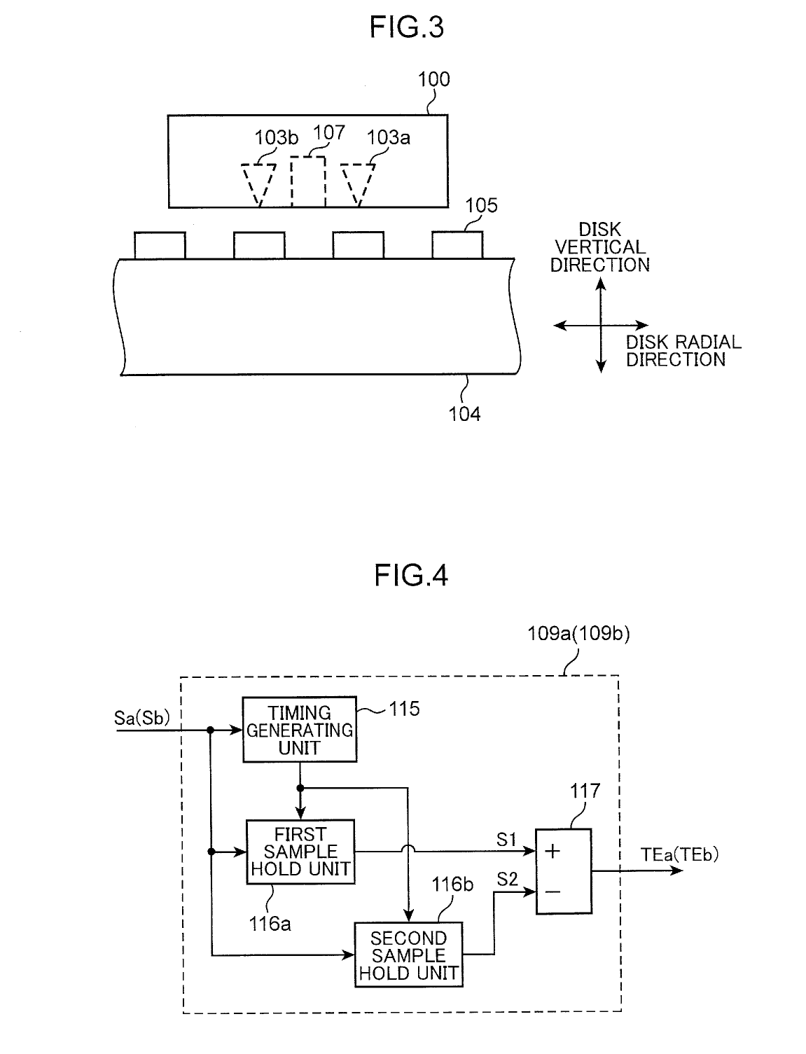

FIG. 1 is a block diagram showing the configuration of an information recording and reproducing device in the first embodiment of the present invention. FIGS. 2 and 3 are schematic diagrams showing an example of the configuration of a slider 100 in FIG. 1. FIG. 2 is a top view showing an example of the configuration of the slider 100 in FIG. 1. In FIG. 2, the up down direction on the paper surface is a track direction. The left right direction on the paper surface is a disk radial direction (a direction orthogonal to the track direction). FIG. 3 is a side view showing an example of the slider 100 in FIG. 1. In FIG. 3, the up down direction on the paper surface is a disk vertical direction. The left right direction on the paper surface is a disk radial direction.

The information recording and reproducing device shown in FIG. 1 includes a slider 100, a suspension arm 108, a first track positional deviation detecting unit 109a, a second track positional deviation detecting unit 109b, a slider control unit 118, an arm motor driving unit 119, an arm motor 120, a heater control unit 121, a heater driving unit 122, a host computer 123, a laser diode driving unit (hereinafter referred to as LD driving unit) 124, and a binarizing unit 125.

As shown in FIGS. 2 and 3, a disk 104 is a patterned medium on which cells 105, which are microstructure protrusions, are regularly arranged. The cells 105 are arrayed in the track direction. Rows of the cells 105 form concentric tracks (alternate long and short dash lines in FIG. 2) on the disk 104. The cells 105 include recording films of a phase change material. The disk 104 rotates a lower part to an upper part on the paper surface in FIG. 2. Further, on the disk 104, information is recorded in order from the track on the left on the paper surface to the track on the right on the paper surface.

As shown in FIGS. 2 and 3, the slider 100 includes a first metal antenna 103a having a triangular flat shape, a second metal antenna 103b having a triangular flat shape, and a heater 107. The first metal antenna 103a and the second metal antenna 103b are respectively arranged on the slider 100 such that the distal ends of the triangular shapes are closest to the surfaces of the cells 105. In addition, the first metal antenna 103a and the second metal antenna 103b are arranged on the slider 100 in the order of the second metal antenna 103b and the first metal antenna 103a from the left on the paper surface such that the distal end of the first metal antenna 103a and the distal end of the second metal antenna 103b are present in positions apart from each other in the disk radial direction by a track interval Tp. The heater 107 is arranged between the first metal antenna 103a and the second metal antenna 103b.

The slider 100 includes the first metal antenna 103a (the first element), the second metal antenna 103b (the second element), and the heater 107 (the inter-element distance varying unit) configured to vary the distance between the first metal antenna 103a (the first element) and the second metal antenna 103b (the second element) in the direction orthogonal to the track direction on the surface of the disk 104 (the information carrier). The first metal antenna 103a is an example of a recording element for recording information on the disk 104 (the information carrier). The second metal antenna 103b is an example of a reproducing element for reproducing information from the disk 104 (the information carrier).

The first metal antenna 103a irradiates a recording target area of the disk 104 with near field light generated by Plasmon resonance with the recording target area to record information on the disk 104. The second metal antenna 103b reproduces the information from the disk 104 by utilizing Plasmon resonance with a reproduction target area of the disk 104.

Note that the width of the cell 105 may be 10 nm to 100 nm. The width of each of the first metal antenna 103a and the second metal antenna 103b is preferably smaller than the wavelength of light irradiated on each of the first metal antenna 103a and the second metal antenna 103b.

The slider 100 includes a first semiconductor laser element 101a, a second semiconductor laser element 101b, a first waveguide 102a, a second waveguide 102b, the first metal antenna 103a, the second metal antenna 103b, a first light receiving element 106a, a second light receiving element 106b, and the heater 107.

FIG. 4 is a block diagram showing the configuration of the first track positional deviation detecting unit 109a and the second track positional deviation detecting unit 109b in FIG. 1.

The first track positional deviation detecting unit 109a detects a positional deviation between the first metal antenna 103a (the recording element) and the track. The second track positional deviation detecting unit 109b detects a positional deviation between the second metal antenna 103b (the reproducing element) and the track. The first track positional deviation detecting unit 109a includes a timing generating unit 115, a first sample hold unit 116a, a second sample hold unit 116b, and a subtracter 117. Note that the configuration of the second track positional deviation detecting unit 109b is the same as the configuration of the first track positional deviation detecting unit 109a. Therefore, explanation of the configuration is omitted.

Note that, in the first embodiment, the first metal antenna 103a is equivalent to an example of the first element and the recording element. The second metal antenna 103b is equivalent to an example of the second element and the reproducing element. The slider 100 is equivalent to an example of the head. The heater 107 is equivalent to an example of the inter-element distance varying unit. The suspension arm 108 and the arm motor 120 are equivalent to an example of the head moving unit. The host computer 123 is equivalent to an example of a checking unit. The first light receiving element 106a and the first track positional deviation detecting unit 109a are equivalent to an example of a recording track positional deviation detecting unit. The second light receiving element 106b and the second track positional deviation detecting unit 109b are equivalent to an example of a reproducing track positional deviation detecting unit.

The operation of the information recording and reproducing device configured as explained above is explained.

The disk 104 is rotated by a disk motor (not shown in the figures). The slider 100 is held by the suspension arm 108 to be opposed to the disk 104. The distance between the slider 100 and the disk 104 is kept constant using a technique same as a flying head adopted in a hard disk drive.

Lights emitted from the first semiconductor laser element 101a and the second semiconductor laser element 101b, which are light sources, are respectively made incident on the first waveguide 102a and the second waveguide 102b having a Y shape, which are optical elements for guiding the lights. The lights are respectively guided to the first metal antenna 103a and the second metal antenna 103b by the first waveguide 102a and the second waveguide 102b.

The first metal antenna 103a and the second metal antenna 103b are respectively resonance elements configured to excite Plasmon resonance using the lights of the first semiconductor laser element 101a and the second semiconductor laser element 101b. The lights guided to the first metal antenna 103a and the second metal antenna 103b excite Plasmon resonance.

On the other hand, reflected lights from the first metal antenna 103a and the second metal antenna 103b are respectively made incident on the first waveguide 102a and the second waveguide 102b, respectively guided to the first light receiving element 106a and the second light receiving element 106b by the first waveguide 102a and the second waveguide 102b, and detected. The first light receiving element 106a and the second light receiving element 106b respectively output a detection signal Sa and a detection signal Sb corresponding to the intensities of the detected reflected lights.

The detection signal Sa and the detection signal Sb output from the first light receiving element 106a and the second light receiving element 106b are respectively input to the first track positional deviation detecting unit 109a and the second track positional deviation detecting unit 109b. The first track positional deviation detecting unit 109a and the second track positional deviation detecting unit 109b respectively generate, on the basis of the detection signal Sa and the detection signal Sb, a tracking error signal (TE signal) TEa and a TE signal TEb indicating positional deviations between the distal ends of the first metal antenna 103a and the second metal antenna 103b having the triangular shape and a track center.

The intensity of the Plasmon resonance of the metal antenna changes according to the distance between the metal antenna and the cell 105. That is, when the metal antenna is close to the cell 105 (when the metal antenna is located in the track center), the intensity of the Plasmon resonance increases. On the other hand, when the metal antenna is away from the cell 105 (when the metal antenna deviates from the track center), the intensity of the Plasmon resonance decreases. Reflected light (or transmitted light) from the metal antenna changes according to the intensity of the Plasmon resonance of the metal antenna. For example, the intensity of the reflected light (the transmitted light) changes according to the intensity of the Plasmon resonance.

Therefore, the intensity of the reflected light (or the transmitted light) from the metal antenna changes according to whether the metal antenna is away from the track center. Tracking error signals can be obtained from the reflected lights from the first metal antenna 103a and the second metal antenna 103b as explained above by making use of this change in the intensity. Alternatively, tracking error signals can also be obtained from transmitted lights transmitted through the first metal antenna 103a and the second metal antenna 103b.

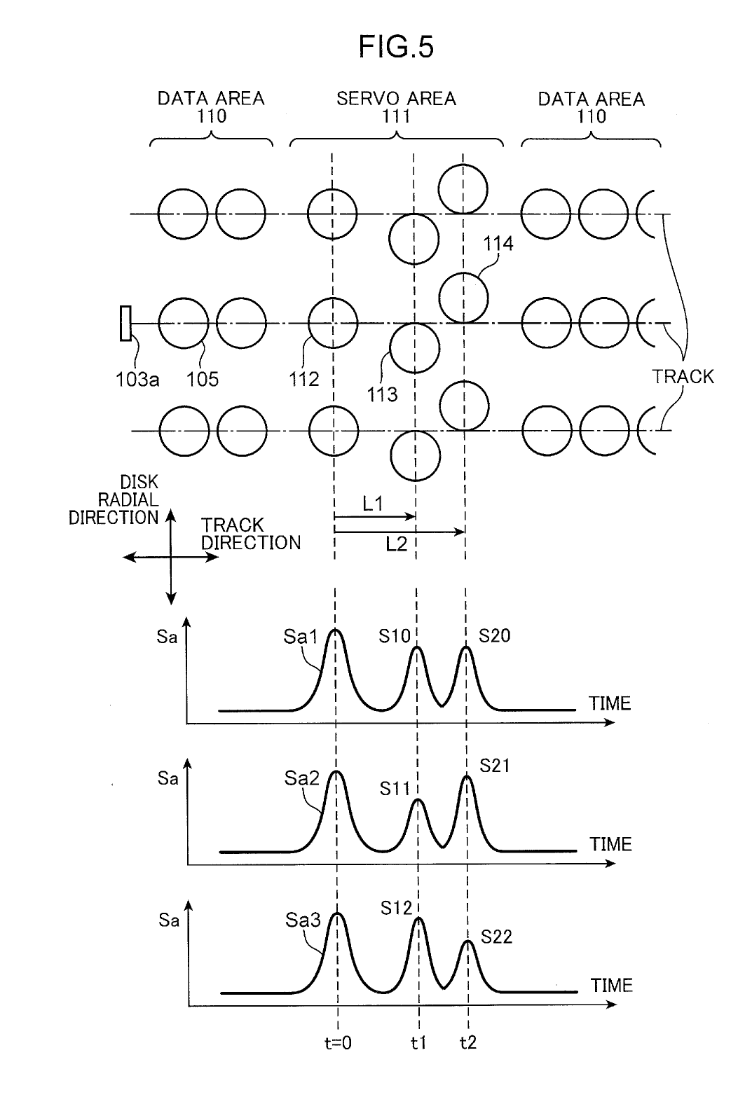

The generation of the TE signal in the first track positional deviation detecting unit 109a is explained. FIG. 5 is a diagram showing an example of arrays of the cells 105 on the tracks on the disk 104 and signals obtained by the light receiving element. In FIG. 5, the up down direction on the paper surface is a disk radial direction, the left right direction on the paper surface is a track direction, and alternate long and short dash lines represent track centers. In FIG. 5, data areas 110 are formed by the cells 105 arranged on the tracks. A phase state of the recording films in the cells 105 changes, whereby data is recorded in the data areas 110. In FIG. 5, a servo area 111 is formed by a trigger mark 112 and wobble marks 113 and 114, which are microstructure protrusions same as the cells 105. The wobble marks 113 and 114 are arranged apart from each other by a predetermined distance in opposite directions from each other in the disk radial direction with respect to the track center. The wobble marks 113 and 114 are respectively arranged distances L1 and L2 apart from the trigger mark 112 in a direction along the tracks.

The first metal antenna 103a moves at relative speed v in the track direction with respect to the disk 104 according to the rotation of the disk 104.

A detection signal Sa1 in FIG. 5 is an example of the detection signal Sa obtained when the distal end of the first metal antenna 103a passes the servo area along the track center. A detection signal Sa2 in FIG. 5 is an example of the detection signal Sa obtained when the distal end of the first metal antenna 103a passes the servo area along the track direction in a state in which the distal end deviates in the disk radial direction upward on the paper surface with respect to the track center. On the other hand, a detection signal Sa3 in FIG. 5 is an example of the detection signal Sa obtained when the distal end of the first metal antenna 103a passes the servo area along the track direction in a state in which the distal end deviates in the disk radial direction downward on the paper surface with respect to the track center.

As indicated by the detection signal Sa1 in FIG. 5, when the first metal antenna 103a passes the servo area along the track center, the detection signal Sa at time t1 (t1=L1/v) when the first metal antenna 103a passes the wobble mark 113 is S10. A value of a detection signal at time t2 (t2=L2/v) when the first metal antenna 103a passes the wobble mark 114 is S20.

As indicated by the detection signal Sa2 in FIG. 5, when the first metal antenna 103a passes the servo area along the track direction while deviating upward on the paper surface from the track center, values of detection signals at time t1 and time t2 are respectively S11 and S21.

As indicated by the detection signal Sa3 in FIG. 5, when the first metal antenna 103a passes the servo area along the track direction while deviating downward on the paper surface from the track center, values of detection signals at time t1 and time t2 are respectively S12 and S22.

The detection signal Sa is a signal corresponding to the reflected light intensity from the first metal antenna 103a. As an example, the reflected light intensity from the first metal antenna 103a is maximized when the distal end of the first metal antenna 103a is located on the center of the microstructure protrusion and decreases as the distal end of the first metal antenna 103a is further away from the center of the microstructure protrusion.

Therefore, values of the detection signals at time t1 and time t2 are S10-S20=0, S11-S21<0, and S12-S22>0.

As explained above, making use of the fact that the reflected light intensity from the first metal antenna 103a changes according to the distance from the center of the microstructure protrusion, it is possible to detect reflected light intensities in the positions of the wobble marks 113 and 114 and detect a positional deviation between the track center and the distal end of the first metal antenna 103a including polarity by calculating a difference between the detected reflected light intensity.

The detection signal Sa is input to the timing generating unit 115, the first sample hold unit 116a, and the second sample hold unit 116b. The timing generating unit 115 generates, on the basis of the input detection signal Sa, two timing signals indicating timings at times t1 and t2 when the distal end of the first metal antenna 103a passes the sides of the wobble marks 113 and 114 with reference to timing when the distal end passes the trigger mark 112. The timing generating unit 115 outputs the timing signals respectively to the first sample hold unit 116a and the second sample hold unit 116b.

The first sample hold unit 116a samples a signal level S1 at time t1 of the detection signal Sa according to the input timing signal, holds the signal level S1, and outputs the signal level S1 to the subtracter 117. The second sample hold unit 116b samples a signal level S2 at time t2 of the detection signal Sa according to the input timing signal, holds the signal level S2, and outputs the signal level S2 to the subtracter 117. The subtracter 117 subtracts the input signal level S2 from the input signal level S1 and outputs a TE signal TEa indicating a positional deviation between the distal end of the first metal antenna 103a and the track center.

On the other hand, generation of a TE signal by the second track positional deviation detecting unit 109b is the same as the generation of the TE signal by the first track positional deviation detecting unit 109a. The second track positional deviation detecting unit 109b generates, from the input detection signal Sb, a TE signal TEb indicating a positional deviation between the distal end of the second metal antenna 103b and the track center and outputs the TE signal TEb.

The servo area 111 is arranged in a plurality of places in the circumference of the disk 104. Discrete TE signals TEa and TE signals TEb obtained in respective servo areas are held by a hold circuit (not shown in the figures) and change to a continuous TE signal.

The TEa signal indicating the positional deviation between the distal end of the first metal antenna 103a and the track center is input to the slider control unit 118. The slider control unit 118 is configured by, for example, a phase compensation circuit and a low-band compensation circuit configured by digital filters by a digital signal processor (hereinafter referred to as DSP). The slider control unit 118 outputs the input TE signal TEa to the arm motor driving unit 119 as an arm motor driving signal. The arm motor driving unit 119 amplifies the input arm motor driving signal and outputs the amplified arm motor driving signal to the arm motor 120. The arm motor 120 moves the suspension arm 108 according to the amplified arm motor driving signal and moves the slider 100 held at the distal end of the suspension arm 108 in the disk radial direction.

According to the operation explained above, track control for controlling the distal end of the first metal antenna 103a to be correctly located in the track center of the disk 104 is realized using the TE signal TEa.

On the other hand, the TE signal TEb indicating the positional deviation between the distal end of the second metal antenna 103b and the track center is input to the heater control unit 121. The heater control unit 121 is configured by a phase compensation circuit and a low-band compensation circuit configured by digital filters by the DSP. The heater control unit 121 outputs the input TE signal TEb to the heater driving unit 122 as a heater driving signal. The heater driving unit 122 amplifies the input heater driving signal and outputs the amplified heater driving signal to the heater 107. The heater 107 generates heat according to the amplified heater driving signal and changes the distance between the first metal antenna 103a and the second metal antenna 103b according to peripheral expansion and contraction corresponding to a heat quantity change. Consequently, the heater 107 moves the second metal antenna 103b in the disk radial direction with respect to the first metal antenna 103a.

According to the operation explained above, track control for controlling the distal end of the second metal antenna 103b to be correctly located in the track center of the disk 104 is realized using the TE signal TEb.

The heater 107 varies the distance between the first metal antenna 103a (the first element) and the second metal antenna 103b (the second element) in the direction orthogonal to the track direction on the surface of the disk 104 (the information carrier).

The arm motor 120 moves the slider 100 (the head) in parallel to the surface of the disk 104 (the information carrier).

The arm motor 120 and the heater 107 cause the first metal antenna 103a (the first element) and the second metal antenna 103b (the second element) to respectively follow corresponding target tracks. The arm motor 120 and the heater 107 cause the first metal antenna 103a (the first element) and the second metal antenna 103b (the second element) to follow tracks in different radial positions. Further, the arm motor 120 and the heater 107 cause the first metal antenna 103a (the first element) and the second metal antenna 103b (the second element) to follow tracks adjacent to each other in the direction orthogonal to the track direction.

For example, the arm motor 120 (the head moving unit) moves the slider 100 such that one of the first metal antenna 103a (the first element) and the second metal antenna 103b (the second element) moves onto a target track. The heater 107 (the inter-element distance varying unit) varies the distance between the first metal antenna 103a (the first element) and the second metal antenna 103b (the second element) in the direction orthogonal to the track direction on the surface of the disk 104 (the information carrier) such that the first metal antenna 103a (the first element) and the second metal antenna 103b (the second element) respectively move onto target tracks. Consequently, the first metal antenna 103a (the first element) and the second metal antenna 103b (the second element) respectively follow the corresponding target tracks.

As explained above, in the information recording and reproducing device in the first embodiment, the track control for the first metal antenna 103a is performed by the TE signal TEa and the arm motor 120. The track control for the second metal antenna 103b is performed by the TE signal TEb and the heater 107. According to the track control, the first metal antenna 103a and the second metal antenna 103b respectively follow tracks adjacent to each other in the radial direction.

Consequently, even when the first metal antenna 103a and the second metal antenna 103b in the slider 100 are manufactured in a state in which the distance between the first metal antenna 103a and the second metal antenna 103b has an error with respect to the track interval Tp, the first metal antenna 103a and the second metal antenna 103b can respectively correctively follow tracks. Even when the slider 100 is rotated and attached with the vertical direction of the disk 104 set as an axis because of an assembly error of the information recording and reproducing device and, although the distance between the first metal antenna 103a and the second metal antenna 103b is the same as the track interval Tp, the distance between the first metal antenna 103a and the second metal antenna 103b in the disk radial direction deviates from the track interval Tp, the first metal antenna 103a and the second metal antenna 103b can respectively correctly follow tracks. Further, even when the track interval Tp of the disk 104 has an error with respect to the correct track interval Tp, the first metal antenna 103a and the second metal antenna 103b can respectively correctly follow tracks.

Therefore, in the information recording and reproducing device in which the recording element and the reproducing element are arranged on one slider and the respective elements are caused to respectively follow tracks, the recording element and the reproducing element can respectively correctly follow tracks according to the track control for the recording element and the track control for the reproducing element. As a result, it is possible to improve recording performance and reproducing performance of the information recording and reproducing device.

In the information recording and reproducing device in the first embodiment, the first metal antenna 103a and the second metal antenna 103b are arranged on the slider 100 to follow tracks adjacent to each other in the radial direction. Therefore, in the information recording and reproducing device in which the recording element and the reproducing element are arranged on one slider and the respective elements are caused to respectively follow tracks, the slider 100 can be reduced in size while being mounted with the recording element and the reproducing element. It is possible to reduce manufacturing costs for the information recording and reproducing device.

Next, recording of information by the first metal antenna 103a is explained.

The host computer 123 outputs a recording data signal to the LD driving unit 124. The LD driving unit 124 outputs a laser element driving signal to the first semiconductor laser element 101a according to modulation of the input recording data signal. The first semiconductor laser element 101a emits light according to the input laser element driving signal. The light emitted from the first semiconductor laser element 101a is guided to the first metal antenna 103a through the first waveguide 102a and excites Plasmon resonance. According to the Plasmon resonance, optical electric-field intensity near the distal end of the first metal antenna 103a having the triangular shape is increased. Consequently, the phase change material forming the recording film of the cells 105 opposed to the first metal antenna 103a changes from a crystal phase to an amorphous phase.

Consequently, it is possible to realize, with the first metal antenna 103a, recording of information in the cells 105 on the disk 104 by utilizing the Plasmon resonance.

Next, reproduction of information by the second metal antenna 103b is explained.

The host computer 123 outputs a reproduction light emission signal for irradiating light with power for reproduction to the LD driving unit 124. The LD driving unit 124 outputs a laser element driving signal to the second semiconductor laser element 101b according to the input reproduction light emission signal. The second semiconductor laser element 101b emits light according to the input laser element driving signal. The light emitted from the second semiconductor laser element 101b is guided to the second metal antenna 103b through the second waveguide 102b and excites Plasmon resonance. The light reflected by the second metal antenna 103b is made incident on the second light receiving element 106b through the second waveguide 102b. The second light receiving element 106b outputs the detection signal Sb corresponding to reflected light intensity from the second metal antenna 103b.

The detection signal Sb representing the reflected light intensity of the second metal antenna 103b is input to the binarizing unit 125. The first metal antenna 103a and the second metal antenna 103b are designed such that the level of a resonance state changes according to whether the phase change material forming the recording films of the cells 105 is in a crystal phase or a amorphous phase. Therefore, it is possible to generate a binarized signal by comparing the detection signal Sb with a predetermined level.

The binarizing unit 125 binarizes the input detection signal Sb and outputs a binarized data signal to the host computer 123.

Consequently, it is possible to realize, with the second metal antenna 103b, reproduction of information in the cells 105 on the disk 104 by utilizing Plasmon resonance.

The host computer 123 reproduces, with the second metal antenna 103b (the reproducing element), information recorded by the first metal antenna 103a (the recording element) in parallel to the recording operation to thereby check whether the recording by the first metal antenna 103a has been correctly performed.

As explained above, in the information recording and reproducing device in the first embodiment, information is recorded in the cells 105 on the tracks by the first metal antenna 103a and the information is reproduced from the cells 105 on the tracks by the second metal antenna 103b. According to the track control, the first metal antenna 103a and the second metal antenna 103b respectively follow tracks adjacent to each other in the radial direction. In the disk 104, information is recorded and the information is reproduced in order from the track on the left on the paper surface to the track on the right on the paper surface in FIG. 2.

Consequently, in the information recording and reproducing device in the first embodiment, while information is recorded by the first metal antenna 103a, after the disk 104 rotates once, the information can be reproduced by the second metal antenna 103b from a track in which the information is recorded. Therefore, it is possible to perform, substantially simultaneously with the recording of the information, a verify operation for checking whether the recording operation has been correctly performed when the information is recorded.

Therefore, in the information recording and reproducing device in which the recording element and the reproducing element are arranged on one slider and the respective elements are caused to follow tracks adjacent to each other in the radial direction, it is possible to perform the verify operation simultaneously with the recording operation by reproducing, in parallel to recording of information, the recorded information. Therefore, it is possible to reduce a required time for the verify operation. As a result, it is possible to improve recording reliability without deteriorating the device performance of the information recording and reproducing device.

Note that, in the first embodiment, the arm motor 120 and the heater 107 cause the recording element and the reproducing element to follow tracks adjacent to each other in the disk radial direction. However, the present invention is not specifically limited to this. That is, the arm motor 120 and the heater 107 may cause the recording element and the reproducing element to follow tracks apart from each other by two or more tracks in the disk radial direction. In this case, effects same as the effects explained above are obtained.

Note that, in the first embodiment, the track control for the first metal antenna 103a (the recording element) is performed by the TE signal TEa and the arm motor 120 (the head moving unit). The track control for the second metal antenna 103b (the reproducing element) is performed by the TE signal TEb and the heater 107 (the inter-element distance varying unit). However, the present invention is not specifically limited to this. The track control for the first metal antenna 103a (the recording element) may be performed by the TE signal TEa and the heater 107 (the inter-element distance varying unit). The track control for the second metal antenna 103b (the reproducing element) may be performed by the TE signal TEb and the arm motor 120 (the head moving unit). In this case, effects same as the effects explained above are obtained.

Note that, in the first embodiment, the verify operation is performed simultaneously with the recording operation by reproducing recorded information in parallel to recording of the information. However, when the recording operation is not performed, the information may be reproduced by the first metal antenna 103a, which is the recording element, using the binarizing unit. The configuration and operations of the information recording and reproducing device are explained below.

The information recording and reproducing device further includes a second binarizing unit in addition to the components in FIG. 1. The second binarizing unit binarizes the detection signal Sa output from the first metal antenna 103a and outputs a binarized data signal to the host computer 123.

In the information recording and reproducing device, the host computer 123 outputs a reproduction light emission signal to the LD driving unit 124. The LD driving unit 124 outputs a laser element driving signal to the first semiconductor laser element 101a according to the input reproduction light emission signal. The first semiconductor laser element 101a emits light at a reproduction light emission level according to the input laser element driving signal. The detection signal Sa, which is the reflected light intensity of the first metal antenna 103a, is input to the second binarizing unit. The second binarizing unit binarizes the input detection signal Sa and outputs a binarized data signal to the host computer 123.

Consequently, it is possible to reproduce, with the first metal antenna 103a, information from the cells 105 on the disk 104 by utilizing Plasmon resonance.

As explained above, in the information recording and reproducing device, information is simultaneously reproduced from the cells 105 on two tracks adjacent to each other by the first metal antenna 103a and the second metal antenna 103b. Consequently, it is possible to reproduce the information at double speed compared with speed in reproducing the information only with the second metal antenna 103b. As a result, it is possible to improve reproducing performance of the information recording and reproducing device.

Note that, in the first embodiment, the verify operation is performed simultaneously with the recording operation by reproducing, in parallel to recording of information, reproducing the recorded information. However, when the verify operation is not performed simultaneously with the recording operation, information may be recorded by the second metal antenna 103b, which is the reproducing element, using an LD driving unit. The configuration and the operation of the information recording and reproducing device are explained below.

The information recording and reproducing device further includes a second LD driving unit in addition to the components in FIG. 1. The second LD driving unit outputs a laser element driving signal to the second semiconductor laser element 101b according to modulation of a recording data signal output from the host computer 123.

In the information recording and reproducing device, the host computer 123 outputs a recording data signal to the second LD driving unit. The second LD driving unit outputs a laser element driving signal to the second semiconductor laser element 101b according to modulation of the input recording data signal. The second semiconductor laser element 101b emits light according to the input laser element driving signal. The light emitted from the second semiconductor laser element 101b is guided to the second metal antenna 103b through the second waveguide 102b and excites Plasmon resonance. According to the Plasmon resonance, optical electric-field intensity near the distal end of the second metal antenna 103b having the triangular shape is increased. Consequently, the phase change material forming the recording films of the cells 105 opposed to the second metal antenna 103b changes from a crystal phase to an amorphous phase.

Consequently, it is possible to realize, with the second metal antenna 103b, recording of information in the cells 105 on the disk 104 by utilizing the Plasmon resonance.

As explained above, in the information recording and reproducing device, information is simultaneously recorded in the cells 105 on two tracks adjacent to each other by the first metal antenna 103a and the second metal antenna 103b. Consequently, it is possible to record the information at double speed compared with speed in recording the information only with the first metal antenna 103a. As a result, it is possible to improve recording performance of the information recording and reproducing device.

Note that, in the first embodiment, the first metal antenna 103a, the second metal antenna 103b, and the heater 107 are arranged on the slider 100 side by side in the disk radial direction as shown in FIG. 2. However, the first metal antenna 103a, the second metal antenna 103b, and the heater 107 may be arranged as explained below.

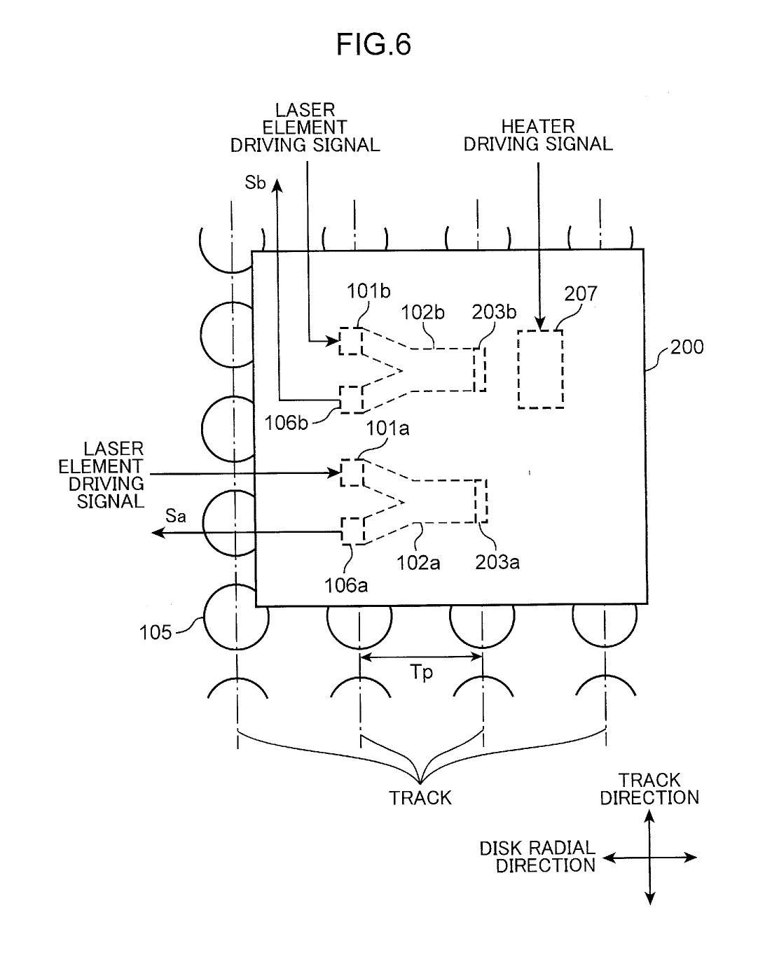

FIG. 6 is a schematic diagram showing the configuration of a slider in an information recording and reproducing device in a first modification of the first embodiment. In FIG. 6, components same as the components in FIG. 2 are denoted by the same reference numerals and signs and explanation of the components is omitted.

As shown in FIG. 6, a slider 200 includes a first metal antenna 203a having a triangular shape, a second metal antenna 203b having a triangular shape, and a heater 207.

The first metal antenna 203a and the second metal antenna 203b are arranged on the slider 200 such that the distal ends of the triangular shapes are closest to the surfaces of the cells 105. In addition, the first metal antenna 203a and the second metal antenna 203b are arranged on the slider 200 in the order of the second metal antenna 203b and the first metal antenna 203a from the upper part on the paper surface such that the distal end of the first metal antenna 203a and the distal end of the second metal antenna 203b are located on tracks in the same disk radial position a predetermined distance apart from each other. That is, the first metal antenna 203a and the second metal antenna 203b are arranged on the same head such that the first metal antenna 203a reaches a position where information on the disk is recorded or reproduced and then the second metal antenna 203b reaches the position. The heater 207 is arranged in the disk radial direction with respect to the second metal antenna 203b.

The arm motor 120 and the heater 207 cause the first metal antenna 203a (the first element) and the second metal antenna 203b (the second element) to follow the same track. The first metal antenna 203a (the recording element) and the second metal antenna 203b (the reproducing element) are arranged such that, when a recording operation or a reproducing operation is performed, the first metal antenna 203a reaches a position where information on the disk 104 is recorded or reproduced and then the second metal antenna 203b reaches the position.

The slider 200 includes the first semiconductor laser element 101a, the second semiconductor laser element 101b, the first waveguide 102a, the second waveguide 102b, the first metal antenna 203a, the second metal antenna 203b, the first light receiving element 106a, the second light receiving element 106b, and the heater 207.

Note that, in the first modification of the first embodiment, the first metal antenna 203a is equivalent to an example of the first element and the recording element. The second metal antenna 203b is equivalent to an example of the second element and the reproducing element. The slider 200 is equivalent to an example of the head. The heater 207 is equivalent to an example of the inter-element distance varying unit.

The distance between the distal end of the first metal antenna 203a and the distal end of the second metal antenna 203b is explained.

In the information recording and reproducing device, in parallel to recording of information by the first metal antenna 203a, the recorded information is reproduced by the second metal antenna 203b. The recording films of the cells 105 are formed of a phase change material. To irradiate light in the cell 105 and generate a mark (an amorphous phase) or a space (a crystal phase), a reaction time from start to finish of a phase change by heat due to an optical electric-field intensified by Plasmon resonance is necessary. Therefore, the distal end of the first metal antenna 203a and the distal end of the second metal antenna 203b need to be arranged apart from each other by a distance equal to or larger than a distance determined from the reaction time and the number of revolutions of the disk 104.

Therefore, the first metal antenna 203a (the recording element) and the second metal antenna 203b (the reproducing element) are arranged apart from each other by a distance equal to or larger than a distance determined on the basis of the number of revolutions of the disk 104 and time from the start to the end of the change of the recording film of the disk 104 at the time when the recording operation is performed.

As explained above, in the information recording and reproducing device in the first modification of the first embodiment, the first metal antenna 203a and the second metal antenna 203b are arranged on the slider 200 to follow tracks in the same disk radial position. The distance between the distal end of the first metal antenna 203a and the distal end of the second metal antenna 203b is set to, at least, a distance necessary for reproducing, in parallel to recording of information, the recorded information.

Therefore, in the information recording and reproducing device in which the recording element and the reproducing element are arranged on one slider and the respective elements are caused to follow the same disk radial direction, it is possible to perform the verify operation simultaneously with the recording operation by reproducing, in parallel to recording of information, the recorded information. Therefore, it is possible to reduce a required time for the verify operation. As a result, it is possible to improve recording reliability without deteriorating the device performance of the information recording and reproducing device.

The slider 200 can be reduced in size while being mounted with the recording element and the reproducing element. It is possible to reduce manufacturing costs for the information recording and reproducing device.

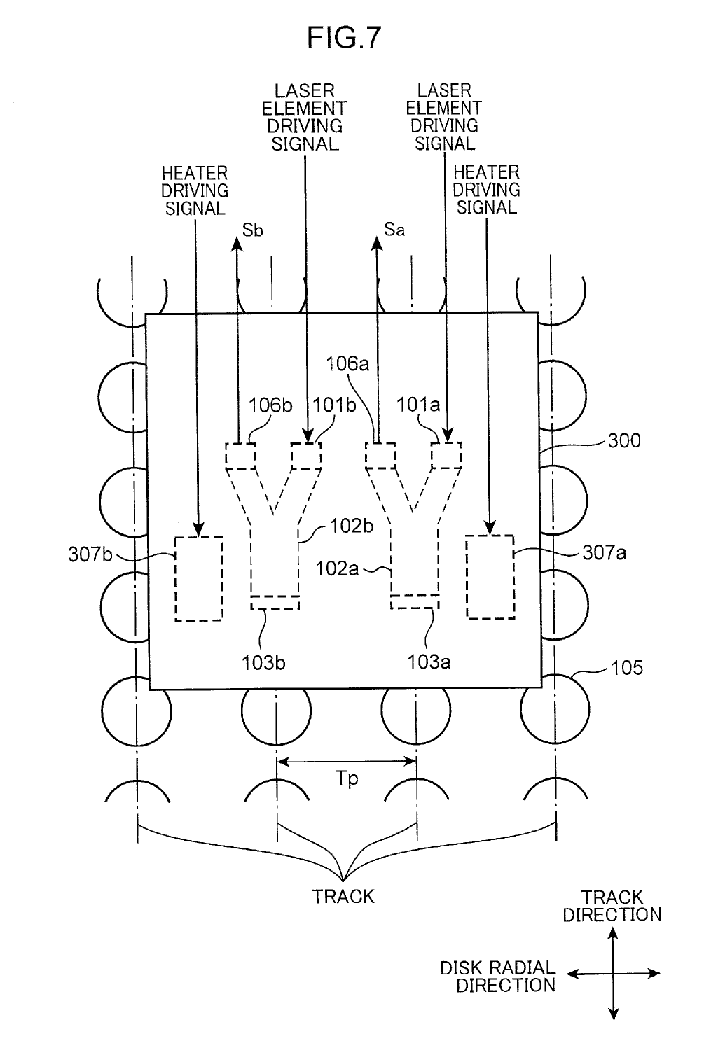

Next, an information recording and reproducing device in a second modification of the first embodiment is explained. FIG. 7 is a schematic diagram showing the configuration of a slider in the information recording and reproducing device in the second modification of the first embodiment. In FIG. 7, components same as the components in FIG. 2 are denoted by the same reference numerals and signs and explanation of the components is omitted.

As shown in FIG. 7, a slider 300 includes the first semiconductor laser element 101a, the second semiconductor laser element 101b, the first waveguide 102a, the second waveguide 102b, the first metal antenna 103a, the second metal antenna 103b, the first light receiving element 106a, the second light receiving element 106b, a first heater 307a, and a second heater 307b.

The first metal antenna 103a and the second metal antenna 103b are arranged on the slider 200 such that the distal ends of the triangular shapes are closest to the surfaces of the cells 105. The first metal antenna 103a and the second metal antenna 103b are arranged side by side in the disk radial direction. In addition, the first metal antenna 103a and the second metal antenna 103b are arranged on the slider 300 in the order of the second metal antenna 103b and the first metal antenna 103a from the left on the paper surface such that the distal end of the first metal antenna 103a and the distal end of the second metal antenna 103b are present in positions apart from each other in the disk radial direction by the track interval Tp.

The first heater 307a is arranged in the left direction on the paper surface (a direction opposite to a direction in which the slider 300 moves) with respect to the first metal antenna 103a. The second heater 307b is arranged in the right direction on the paper surface (the direction in which the slider 300 moves) with respect to the second metal antenna 103b.

Note that the slider 300 may include only one of the first heater 307a and the second heater 307b.

As explained above, a heater is absent between the first metal antenna 103a and the second metal antenna 103b. Therefore, it is possible to further reduce the distance between the first metal antenna 103a and the second metal antenna 103b. It is possible to record information in or reproduce information from a high-density disk having a narrow track pitch.

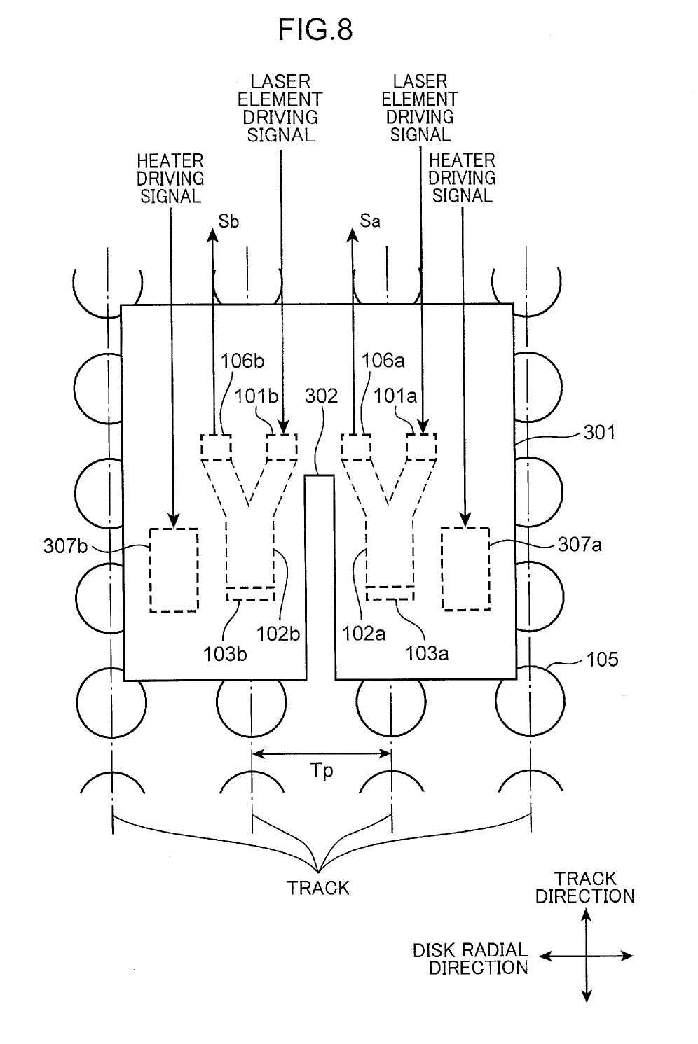

Next, an information recording and reproducing device in a third modification of the first embodiment is explained. FIG. 8 is a schematic diagram showing the configuration of a slider in the information recording and reproducing device in the third modification of the first embodiment. In FIG. 8, components same as the components in FIGS. 2 and 7 are denoted by the same reference numerals and signs and explanation of the components is omitted.

As shown in FIG. 8, a slider 301 includes the first semiconductor laser element 101a, the second semiconductor laser element 101b, the first waveguide 102a, the second waveguide 102b, the first metal antenna 103a, the second metal antenna 103b, the first light receiving element 106a, the second light receiving element 106b, the first heater 307a, and the second heater 307b.

The first metal antenna 103a and the second metal antenna 103b are arranged on the slider 200 such that the distal ends of the triangular shapes are closest to the surfaces of the cells 105. The first metal antenna 103a and the second metal antenna 103b are arranged side by side in the disk radial direction. In addition, the first metal antenna 103a and the second metal antenna 103b are arranged on the slider 301 in the order of the second metal antenna 103b and the first metal antenna 103a from the left on the paper surface such that the distal end of the first metal antenna 103a and the distal end of the second metal antenna 103b are present in positions apart from each other in the disk radial direction by the track interval Tp.

The first heater 307a is arranged in the left direction on the paper surface (a direction opposite to a direction in which the slider 300 moves) with respect to the first metal antenna 103a. The second heater 307b is arranged in the right direction on the paper surface (the direction in which the slider 300 moves) with respect to the second metal antenna 103b.

A cutout section 302 is formed between the first metal antenna 103a and the second metal antenna 103b. The cutout section 302 is formed by cutting out a part on a substrate including the first metal antenna 103a and the second metal antenna 103b.

As explained above, the cutout section 302 is formed between the first metal antenna 103a and the second metal antenna 103b. Consequently, heat from the first heater 307a is not transmitted to the second metal antenna 103b side. Heat from the second heater 307b is not transmitted to the first metal antenna 103a side. Therefore, the first heater 307a can move only the first metal antenna 103a in the disk radial direction. The second heater 307b can move only the second metal antenna 103b in the disk radial direction.

Note that the slider 301 may include only one of the first heater 307a and the second heater 307b.

Note that, in the first embodiment, the metal antenna is used for the recording element to excite Plasmon resonance. The phase change material of the recording films in the cells 105 on the disk 104, which is a patterned medium, is subjected to phase change to record information. The metal antenna is used for the reproducing element to detect a phase state of the phase change material of the recording films in the cells 105 as the level of a Plasmon resonance state to thereby reproduce the information. However, a method of recording or reproducing information and the structure of a disk are not limited to the above. That is, a recording method for the information recording and reproducing device may be a magnetic recording method or the like in which a magnetic element and a magnetic disk used in a hard disk drive are used. In this case, effects same as the effects explained above are obtained.

Note that, in the first embodiment, the heater is used as the inter-element distance varying unit. The distance in the disk radial direction between the recording element and the reproducing element is varied according to heat generation of the heater making use of peripheral expansion and contraction corresponding to a heat value change. However, the present invention is not specifically limited to this. That is, the distance in the disk radial direction between the recording element and the reproducing element may be varied using, for example, a piezoelectric element. In this case, effects same as the effects explained above are obtained.

Note that, in the first and second track positional shift detecting units in the first embodiment, the TE signal is generated from the detection signal obtained when the metal antenna passes the discrete servo area 111 on the disk 104. However, the present invention is not specifically limited to this. That is, for example, a TE signal indicating a positional deviation of the recording element or the reproducing element with respect to the track center may be generated from detection signals continuously obtained in the data area 110. In this case, effects same as the effects explained above are obtained.

Note that, in the first embodiment, a signal is reproduced using the binarizing unit. However, the present invention is not specifically limited to this. That is, for example, a configuration in which a signal is reproduced using, for example, a waveform equalization circuit may be adopted.

Note that, in the first embodiment, the rotating direction of the disk 104 is set in the direction from the lower part on the paper surface to the upper part on the paper surface in FIG. 2. The recording direction of the tracks on the disk 104 is set in the direction from the left on the paper surface to the right on the paper surface in FIG. 2. However, the present invention is not specifically limited to this. That is, the arrangement of the recording element and the reproducing element on the slider only has to be qualitatively the same as the arrangement in the first embodiment with respect to the rotating direction of the disk and the recording direction of the tracks. In this case, effects same as the effects explained above are obtained.

### Second Embodiment

In a second embodiment, an information recording and reproducing device is explained as an example of the information device. A disk is explained as an example of the information carrier. A recording element for recording information on the information carrier is explained as an example of the first element. A reproducing element for reproducing the information from the information carrier is explained as an example of the second element.

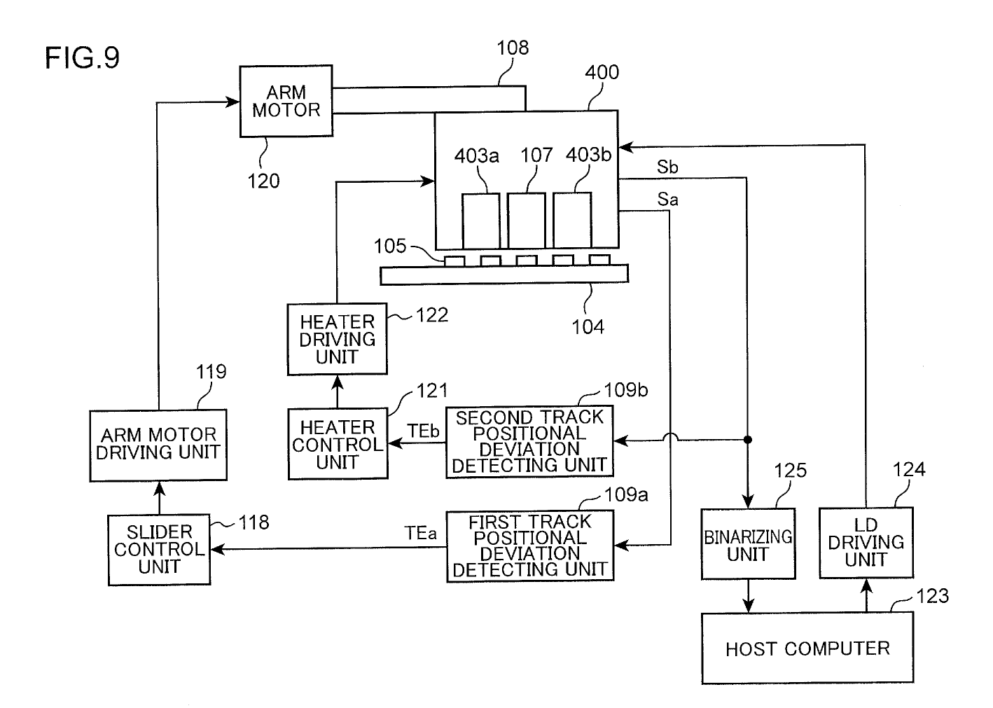

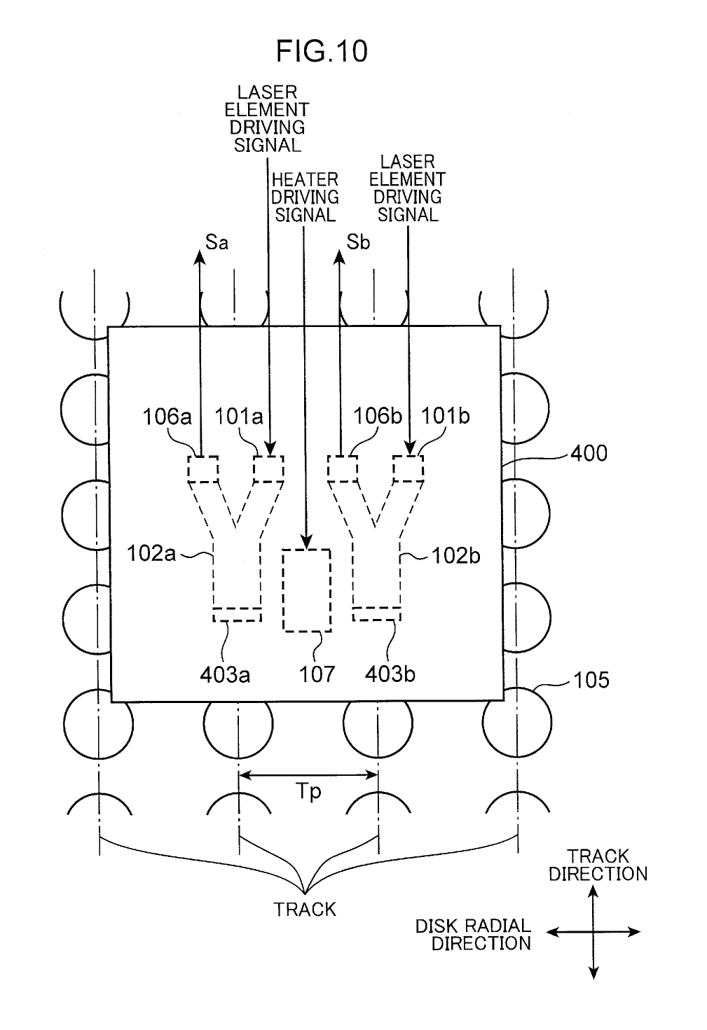

FIG. 9 is a block diagram showing the configuration of an information recording and reproducing device in the second embodiment of the present invention. FIG. 10 is a schematic diagram showing an example of the configuration of a slider 400 in FIG. 9. Note that, in the second embodiment, components same as the components in the first embodiment are denoted by the same reference numerals and signs and explanation of the components is omitted.

The information recording and reproducing device shown in FIG. 9 includes the slider 400, the suspension arm 108, the first track positional deviation detecting unit 109a, the second track positional deviation detecting unit 109b, the slider control unit 118, the arm motor driving unit 119, the arm motor 120, the heater control unit 121, the heater driving unit 122, the host computer 123, the LD driving unit 124, and the binarizing unit 125.

As shown in FIG. 10, the slider 400 includes a first metal antenna 403a having a triangular shape, a second metal antenna 403b having a triangular shape, and the heater 107. The first metal antenna 403a and the second metal antenna 403b are respectively arranged on the slider 400 such that distal ends of the triangular shapes are closest to the surfaces of the cells 105. In addition, the first metal antenna 403a and the second metal antenna 403b are arranged on the slider 400 in the order of the first metal antenna 403a and the second metal antenna 403b from the left on the paper surface such that the distal end of the first metal antenna 403a and the distal end of the second metal antenna 403b are present in positions apart from each other in the disk radial direction by the track interval Tp. The heater 107 is arranged between the first metal antenna 403a and the second metal antenna 403b.

The slider 400 includes the first semiconductor laser element 101a, the second semiconductor laser element 101b, the first waveguide 102a, the second waveguide 102b, the first metal antenna 403a, the second metal antenna 403b, the first light receiving element 106a, the second light receiving element 106b, and the heater 107.

The first metal antenna 403a (the recording element) and the second metal antenna 403b (the reproducing element) are arranged such that, when the recording operation or the reproducing operation is performed, the second metal antenna 403b reaches a position where information is recorded or reproduced on the disk 104 and then the first metal antenna 403a reaches the position. The host computer 123 records, with the first metal antenna 403a (the recording element), in parallel to the reproducing operation, the information reproduced by the second metal antenna 403b (the recording element) to thereby overwrite the information recorded on the disk 104.

Note that, in the second embodiment, the first metal antenna 403a is equivalent to an example of the first element and the recording element. The second metal antenna 403b is equivalent to an example of the second element and the reproducing element. The slider 400 is equivalent to an example of the head. The host computer 123 is equivalent to an example of an overwrite processing unit.

The operation of the information recording and reproducing device configured as explained above is explained.

The detection signal Sb, which is the reflected light intensity of the second metal antenna 403b, is input to the second track positional deviation detecting unit 109b and the binarizing unit 125. The binarizing unit 125 binarizes the input detection signal Sb and outputs a binarized data signal to the host computer 123. The host computer 123 delays the input binarized data signal by time equivalent to one rotation of the disk 104 and outputs the binarized data signal to the LD driving unit 124 as a recording data signal. Consequently, the information already recorded on the disk 104 is overwritten in the same position of the disk 104.

Consequently, when a refresh recording operation for overwriting the information already recorded on the disk 104 in the same position of the disk 104 is performed, it is possible to reproduce the information from the disk 104 and, after the disk 104 rotates once, record the information reproduced from the disk 104 in a position same as a reproducing position of the disk 104.

As explained above, in the information recording and reproducing device in the second embodiment, information is reproduced from the cell 105 on the track by the second metal antenna 403b. The information is recorded in the cell 105 on the track by the first metal antenna 403a. According to track control, the first metal antenna 403a and the second metal antenna 403b respectively follow tracks adjacent to each other in the radial direction. The information is reproduced and recorded in order from the track on the left on the paper surface to the track on the right on the paper surface in FIG. 10.

Consequently, in the information recording and reproducing device in the second embodiment, while information is reproduced by the second metal antenna 403b, after the disk 104 rotates once, the information can be recorded by the first metal antenna 403a on the track from which the information is reproduced can be recorded. Therefore, it is possible to perform, substantially simultaneously with the reproduction of the information, a refresh recording operation for overwriting and recording again information recorded on a disk.

Therefore, in the information recording and reproducing device in which the reproducing element and the recording element are arranged on one slider and the respective elements are caused to follow tracks adjacent to each other in the radial direction, it is possible to record, in parallel to reproduction of information, the reproduced information in a position same as a reproducing position of the disk 104. Therefore, it is possible to reduce a required time of an overwriting and recording operation for recording again information recorded in the past. As a result, it is possible to improve reliability of recorded information without deteriorating the performance of the information recording and reproducing device.

Note that, in the second embodiment, the arm motor 120 and the heater 107 cause the reproducing element and the recording element to follow tracks adjacent to each other in the disk radial direction. However, the present invention is not specifically limited to this. The arm motor 120 and the heater 107 may cause the recording element and the reproducing element to follow tracks apart from each other by two or more tracks in the disk radial direction. In this case, effects same as the effects explained above are obtained.

Note that, in the second embodiment, the track control for the first metal antenna 403a (the recording element) is performed by the TE signal TEa and the arm motor 120 (the head moving unit). The track control for the second metal antenna 403b (the reproducing element) is performed by the TE signal TEb and the heater 107 (the inter-element distance varying unit). However, the present invention is not specifically limited to this. The track control for the first metal antenna 403a (the recording element) may be performed by the TE signal TEa and the heater 107 (the inter-element distance varying unit). The track control for the second metal antenna 403b (the reproducing element) may be performed by the TE signal TEb and the arm motor 120 (the head moving unit). In this case, effects same as the effects explained above are obtained.

Note that, in the second embodiment, when the refresh recording operation is performed, the host computer 123 outputs the binarized data signal to the LD driving unit 124. However, the present invention is not specifically limited to this and may be configured as explained below. That is, it is determined, using an index indicating reproducing signal quality of information reproduced from the disk 104, whether the refresh recording operation is necessary. When it is determined that the refresh recording operation is necessary, the host computer 123 may output the binarized data signal to the LD driving unit 124.

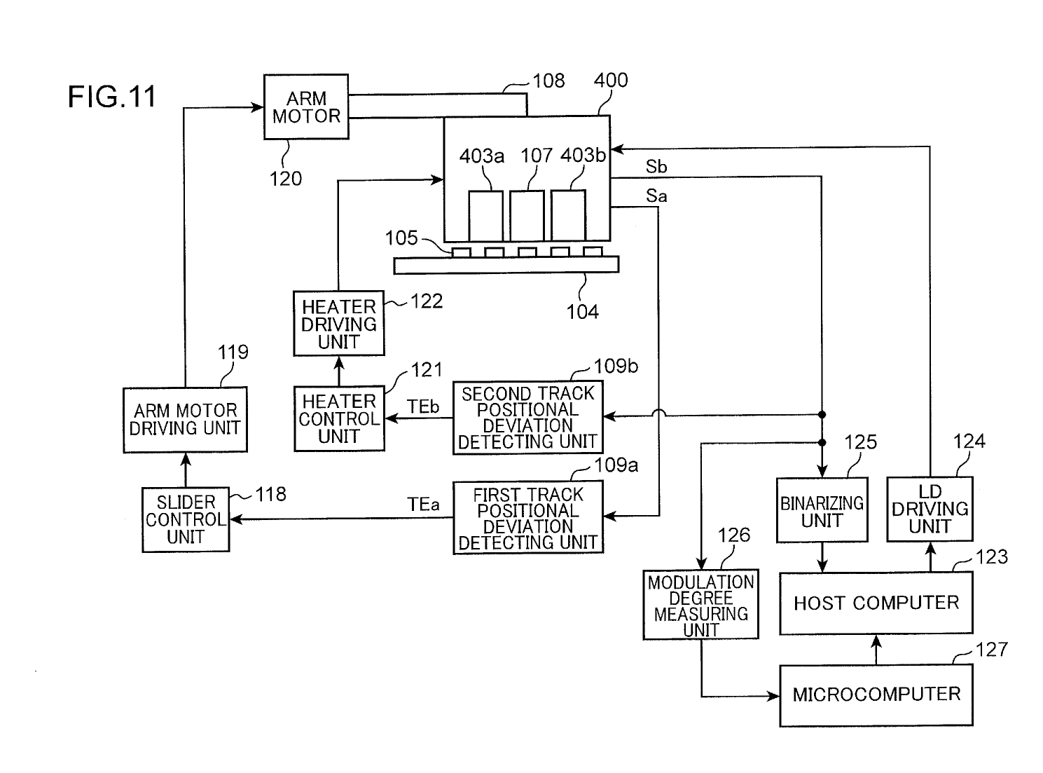

The operation of an information recording and reproducing device in a first modification of the second embodiment is explained below with reference to FIG. 11.

FIG. 11 is a block diagram showing the configuration of the information recording and reproducing device in the first modification of the second embodiment. In the first modification of the second embodiment, the information recording and reproducing device reproduces information recorded on the disk 104, determines necessity of the refresh recording operation using an index indicating reproducing signal quality of the reproduced information, and, when it is determined that the refresh recording operation is necessary, performs the refresh recording operation. In FIG. 11, components same as the components in FIG. 9 are denoted by the same reference numerals and signs and explanation of the components is omitted.

The information recording and reproducing device shown in FIG. 11 includes the slider 400, the suspension arm 108, the first track positional deviation detecting unit 109a, the second track positional deviation detecting unit 109b, the slider control unit 118, the arm motor driving unit 119, the arm motor 120, the heater control unit 121, the heater driving unit 122, the host computer 123, the LD driving unit 124, the binarizing unit 125, a modulation degree measuring unit 126, and a microcomputer 127.

The modulation degree measuring unit 126 measures a modulation degree of a reproducing signal obtained when the information recorded on the disk 104 is reproduced.

The microcomputer 127 reproduces, with the second metal antenna 403b (reproducing element), the information recorded on the disk 104 and determines, on the basis of a measurement result from the modulation degree measuring unit 126, the recording quality of the information recorded in the disk 104. Note that the microcomputer 127 compares the modulation degree measured by the modulation degree measuring unit 126 and a predetermined threshold. When the modulation degree does not exceed the predetermined threshold, the microcomputer 127 determines that the recording quality of the information recorded on the disk 104 is satisfactory. When the modulation degree exceeds the predetermined threshold, the microcomputer 127 determines that the recording quality of the information recorded on the disk 104 is poor.

When it is determined by the microcomputer 127 that the recording quality is poor, the host computer 123 records, with the first metal antenna 403a (the recording element), in parallel to the reproducing operation, the information reproduced by the second metal antenna 403b (the reproducing element) in a position where the information is recorded on the disk 104 to thereby overwrite the information recorded on the disk 104.

Note that, in the first modification of the second embodiment, the modulation degree measuring unit 126 is equivalent to an example of a reproducing signal quality measuring unit, the microcomputer 127 is equivalent to an example of a recording quality determining unit, and the host computer 123 is equivalent to an example of the overwrite processing unit.

The operation of the information recording and reproducing device in the first modification of the second embodiment configured as explained above is explained.

The detection signal Sb, which is the reflected light intensity of the second metal antenna 403b, is input to the second track positional deviation detecting unit 109b, the binarizing unit 125, and the modulation degree measuring unit 126. The modulation degree measuring unit 126 measures a modulation degree of the input detection signal Sb and outputs the measured modulation degree to the microcomputer 127. The microcomputer 127 checks the recording quality of the recorded signal from the input modulation degree. When the recording quality is poor, the microcomputer 127 determines that refresh recording is necessary. When it is determined that the refresh recording is necessary, the microcomputer 127 outputs, to the host computer 123, a notification signal for urging the host computer 123 to execute the refresh recording. When the notification signal is input, the host computer 123 executes the refresh recording operation.

Consequently, the recording quality of the reproducing signal is determined on the basis of the modulation degree of the reproducing signal obtained by reproducing the information recorded on the disk 104. When the recording quality of the reproducing signal is poor, the refresh recording operation is executed.

Therefore, in the information recording and reproducing device in which the reproducing element and the recording element are arranged on one slider and the respective elements are caused to follow tracks adjacent to each other in the radial direction, it is possible to execute, when information is reproduced, an overwrite recording operation for recording the information again according to the recording quality of a signal. As a result, it is possible to improve reliability of recorded information without deteriorating the performance of the information recording and reproducing device.

Note that, in the second embodiment, the refresh recording operation is performed simultaneously with the reproducing operation by recording, in parallel to reproduction of information, the reproduced information in a position same as a reproducing position of the disk. However, when the refresh recording operation is not performed, the information may be reproduced by the first metal antenna 403a, which is the recording element, using the binarizing unit. The configuration and the operation of the information recording and reproducing device are explained below.

The information recording and reproducing device further includes the second binarizing unit in addition to the components in FIG. 9. The second binarizing unit binarizes the detection signal Sa output from the first metal antenna 403a and outputs a binarized data signal to the host computer 123.

In the information recording and reproducing device, the host computer 123 outputs a reproduction light emission signal to the LD driving unit 124. The LD driving unit 124 outputs a laser element driving signal to the first semiconductor laser element 101a according to the input reproduction light emission signal. The first semiconductor laser element 101a emits light at a reproduction light emission level according to the input laser element driving signal. The detection signal Sa, which is the reflected light intensity of the first metal antenna 403a, is input to the second binarizing unit. The second binarizing unit binarizes the input detection signal Sa and outputs a binarized data signal to the host computer 123.

Consequently, it is possible to reproduce, with the first metal antenna 403a, information from the cells 105 on the disk 104 by utilizing Plasmon resonance.

As explained above, in the information recording and reproducing device, information is simultaneously reproduced from the cells 105 on two tracks adjacent to each other by the first metal antenna 403a and the second metal antenna 403b. Consequently, it is possible to reproduce the information at double speed compared with speed in reproducing the information only with the second metal antenna 403b. As a result, it is possible to improve reproducing performance of the information recording and reproducing device.

Note that, in the second embodiment, the refresh recording operation is performed simultaneously with the reproducing operation by recording, in parallel to reproduction of information, the reproduced information in a position same as a reproducing position of the disk. However, when the refresh recording operation is not performed simultaneously with the reproducing operation, the information may be recorded by the second metal antenna 403b, which is the reproducing element, using the LD driving unit. The configuration and the operation of the information recording and reproducing device are explained below.

The information recording and reproducing device further includes the second LD driving unit in addition to the components in FIG. 9. The second LD driving unit outputs a laser element driving signal to the second semiconductor laser element 101b according to modulation of a recording data signal output from the host computer 123.

In the information recording and reproducing device, the host computer 123 outputs a recording data signal to the second LD driving unit. The second LD driving unit outputs a laser element driving signal to the second semiconductor laser element 101b according to modulation of the input recording data signal. The second semiconductor laser element 101b emits light according to the input laser element driving signal. The light emitted from the second semiconductor laser element 101b is guided to the second metal antenna 403b through the second waveguide 102b and excites Plasmon resonance. According to the Plasmon resonance, optical electric-field intensity near the distal end of the second metal antenna 403b having the triangular shape is increased. Consequently, the phase change material forming the recording films of the cells 105 opposed to the second metal antenna 403b changes from a crystal phase to an amorphous phase.

Consequently, it is possible to realize, with the second metal antenna 403b, recording of information in the cells 105 on the disk 104 by utilizing the Plasmon resonance.

As explained above, in the information recording and reproducing device, information is simultaneously recorded in the cells 105 on two tracks adjacent to each other by the first metal antenna 403a and the second metal antenna 403b. Consequently, it is possible to record the information at double speed compared with speed in recording the information only with the first metal antenna 403a. As a result, it is possible to improve recording performance of the information recording and reproducing device.

Note that, in the second embodiment, the refresh recording operation is performed simultaneously with the reproducing operation by recording, in parallel to reproduction of information, the reproduced information in a position same as a reproducing position of the disk. However, the present invention is not specifically limited to this. The information recording and reproducing device may be configured to be capable of recording and reproducing information in both the two metal antennas using the binarizing unit and the LD driving unit. The recording and the reproduction in the two metal antennas may be switched. Consequently, it is possible to not only perform the refresh recording operation simultaneously with the reproducing operation but also perform the verify operation simultaneously with the recording operation. The configuration of the information recording and reproducing device and the operation in performing the verify operation simultaneously with the recording operation are explained below.

The information recording and reproducing device further includes the second binarizing unit and the second LD driving unit in addition to the components in FIG. 9. The second binarizing unit binarizes the detection signal Sa output from the first metal antenna 403a and outputs a binarized data signal to the host computer 123. The second LD driving unit outputs a laser element driving signal to the second semiconductor laser element 101b according to modulation of a recording data signal output from the host computer 123.

In the information recording and reproducing device, when the verify operation is performed simultaneously with the recording operation, the host computer 123 outputs the recording data signal to the second LD driving unit. The second LD driving unit outputs a laser element driving signal to the second semiconductor laser element 101b according to modulation of the input recording data signal. The second semiconductor laser element 101b emits light according to the input laser element driving signal. The light emitted from the second semiconductor laser element 101b is guided to the second metal antenna 403b through the second waveguide 102b and excites Plasmon resonance. According to the Plasmon resonance, optical electric-field intensity near the distal end of the second metal antenna 403b having the triangular shape is increased. Consequently, the phase change material forming the recording films of the cells 105 opposed to the second metal antenna 403b changes from a crystal phase to an amorphous phase.

Consequently, it is possible to realize, with the second metal antenna 403b, recording of information in the cells 105 on the disk 104 by utilizing the Plasmon resonance.

The host computer 123 outputs a reproduction light emission signal to the LD driving unit 124. The LD driving unit 124 outputs a laser element driving signal to the first semiconductor laser element 101a according to the input reproduction light emission signal. The first semiconductor laser element 101a emits light at a reproduction light emission level according to the input laser element driving signal. The detection signal Sa, which is the reflected light intensity of the first metal antenna 403a, is input to the second binarizing unit. The second binarizing unit binarizes the input detection signal Sa and outputs a binarized data signal to the host computer 123.

Consequently, it is possible to reproduce, with the first metal antenna 403a, information from the cells 105 on the disk 104 by utilizing Plasmon resonance.

As explained above, in the information recording and reproducing device, when the verify operation is performed simultaneously with the recording operation, it is possible to reproduce, with the first metal antenna 403a, while recording information with the second metal antenna 403b, after the disk 104 rotates once, the information from a track in which the information is recorded.

Therefore, in the information recording and reproducing device in which the recording element and the reproducing element are arranged on one slider and the respective elements are caused to follow tracks adjacent to each other in the radial direction, it is possible to switch the refresh recording operation for recording, in parallel to reproduction of information, the reproduced information in a position same as a reproducing position of a disk, and the verify operation for checking whether the information has been correctly recorded by reproducing the recorded information in parallel to recording of information. As a result, it is possible to improve recording reliability without deteriorating the performance of the information recording and reproducing device.

Note that, in the first embodiment, the verify operation is performed simultaneously with recording of information. However, like the configuration of the information recording and reproducing device in the second embodiment, the information recording and reproducing device may be configured to be capable of recording and reproducing information in both the two metal antennas using the second binarizing unit and the second LD driving unit and switch recording and reproduction in the two metal antennas. Consequently, it is possible to not only perform the verify operation simultaneously with the recording operation but also perform the refresh recording operation simultaneously with the reproducing operation.

Note that, in the second embodiment, as shown in FIG. 10, the first metal antenna 403a, the second metal antenna 403b, and the heater 107 are arranged on the slider 400 side by side in the disk radial direction. However, the first metal antenna 403a, the second metal antenna 403b, and the heater 107 may be arranged as explained below.

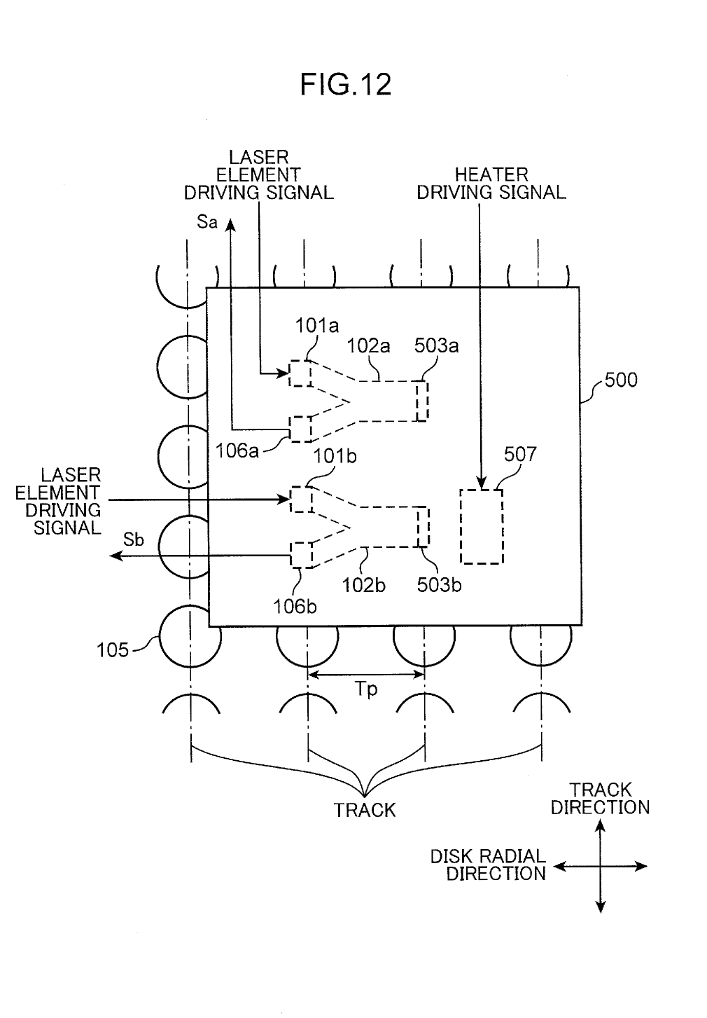

FIG. 12 is a schematic diagram showing the configuration of a slider in an information recording and reproducing device in a second modification of the second embodiment. In FIG. 12, components same as the components in FIG. 10 are denoted by the same reference numerals and signs and explanation of the components is omitted.

As shown in FIG. 12, a slider 500 includes a first metal antenna 503a having a triangular shape, a second metal antenna 503b having a triangular shape, and a heater 507.

The first metal antenna 503a and the second metal antenna 503b are arranged on the slider 500 such that the distal ends of the triangular shapes are closest to the surfaces of the cells 105. In addition, the first metal antenna 503a and the second metal antenna 503b are arranged on the slider 500 in the order of the first metal antenna 503a and the second metal antenna 503b from the upper part on the paper surface such that the distal end of the first metal antenna 503a and the distal end of the second metal antenna 503b are located on tracks in the same disk radial position a predetermined distance apart from each other. That is, the first metal antenna 503a and the second metal antenna 503b are arranged on the same head such that the second metal antenna 503b reaches a position where information on the disk is recorded or reproduced and then the first metal antenna 503a reaches the position. The heater 507 is arranged in the disk radial direction with respect to the second metal antenna 503b.

The arm motor 120 and the heater 207 cause the first metal antenna 503a (the first element) and the second metal antenna 503b (the second element) to follow the same track. The first metal antenna 503a (the recording element) and the second metal antenna 503b (the reproducing element) are arranged such that, when the recording operation or the reproducing operation is performed, the second metal antenna 503b reaches a position where information on the disk 104 is recorded or reproduced and then the first metal antenna 503a reaches the position.

The slider 500 includes the first semiconductor laser element 101a, the second semiconductor laser element 101b, the first waveguide 102a, the second waveguide 102b, the first metal antenna 503a, the second metal antenna 503b, the first light receiving element 106a, the second light receiving element 106b, and the heater 507.

Note that, in the second modification of the second embodiment, the first metal antenna 503a is equivalent to an example of the first element and the recording element. The second metal antenna 503b is equivalent to an example of the second element and the reproducing element. The slider 500 is equivalent to an example of the head. The heater 507 is equivalent to an example of the inter-element distance varying unit.

The operation of the information recording and reproducing device configured as explained above is explained.

The detection signal Sb, which is the reflected light intensity of the second metal antenna 503b, is input to the second track positional deviation detecting unit 109b and the binarizing unit 125. The binarizing unit 125 binarizes the input detection signal Sb and outputs a binarized data signal to the host computer 123. When the refresh recording operation is performed, the host computer 123 outputs the input binarized data signal to the LD driving unit 124 as a recording data signal.

The distance between the distal end of the first metal antenna 503a and the distal end of the second metal antenna 503b is explained.

In this configuration, it is assumed that the refresh recording operation is performed. When the refresh recording operation is performed, in parallel to reproduction of information by the second metal antenna 503b, the reproduced information is recorded in a position same as a reproducing position of the disk 104 by the first metal antenna 503a.

In the reproduction of the information by the second metal antenna 503b, the detection signal Sb, which is the reflected light intensity from the second metal antenna 503b, changes to a binarized signal through the binarizing unit 125. The binarized signal is input to the host computer 123. In the reproducing operation explained above, a fixed time is necessary after the second metal antenna 503b reaches the cell 105, from which information should be reproduced, until the binarized signal is input to the host computer 123.

That is, time necessary during reproduction is a reproducing signal transmission delay time required until a signal reaches the binarizing unit 125 from the second light receiving element 106b and reaches the host computer 123 from the binarizing unit 125 in a reproducing signal transmission line, which connects the second light receiving element 106b, the binarizing unit 125, and the host computer 123, and a binarizing circuit delay time required for the detection signal Sb to be binarized in an electronic circuit or the like in the binarizing unit 125.

The host computer 123 outputs the input binarized data signal to the LD driving unit 124. The LD driving unit 124 outputs a laser driving signal to the first semiconductor laser element 101a according to the input signal. Light emitted from the first semiconductor laser element 101a according to the laser driving signal is guided to the first metal antenna 503a through the first waveguide 102a and excites Plasmon resonance. Consequently, the information is recorded in the disk 104 by the first metal antenna 503a. In the recording operation, a fixed time is necessary after the host computer 123 outputs the binarized data signal, which should be recorded, until the Plasmon resonance is excited by the first metal antenna 503a.

That is, time necessary during the recording is a recording signal transmission delay time required until a signal reaches the LD driving unit 124 from the host computer 123 and reaches the first semiconductor laser element 101a from the LD driving unit 124 in a recording signal transmission line, which connects the host computer 123, the LD driving unit 124, and the first semiconductor laser element 101a.

Therefore, the distance between the distal end of the second metal antenna 503b and the distal end of the first metal antenna 503a needs to be equal to or larger than a distance determined from the number of revolutions of the disk 104 and a total time of the reproducing signal transmission delay time, the binarizing circuit delay time, and the recording signal transmission delay time.

Therefore, the first metal antenna 503a (the recording element) and the second metal antenna 503b (the reproducing element) are arranged apart from each other by a distance equal to or larger than a distance determined on the basis of the number of revolutions of the disk 104, and a total time of a reproduction delay time required for a reproducing signal to pass a reproducing signal transmission line through which the reproducing signal is transmitted, a circuit delay time required for processing the reproducing signal, and a recording delay time required for a recording signal to pass a recording signal transmission line through which the recording signal is transmitted.

Consequently, when the refresh recording operation is performed, it is possible to record information reproduced from the disk 104 in a position same as a reproducing position of the disk 104.

As explained above, in the configuration in the second modification of the second embodiment, the second metal antenna 503b and the first metal antenna 503a are arranged on the slider 500 to follow tracks in the same disk radial position. The distance between the distal end of the second metal antenna 503b and the distal end of the first metal antenna 503a is at least a distance necessary for recording, in parallel to reproduction of information, the reproduced information in a position same as a reproducing position.

Therefore, in the information recording and reproducing device in which the reproducing element and the recording element are arranged on one slider and the respective elements are caused to follow the same disk radial position, in parallel to reproduction of information, the reproduced information can be recorded in a position same as a reproducing position of the disk 104. Therefore, it is possible to reduce a required time of an overwrite recording operation for recording again information recorded in the past. As a result, it is possible to improve reliability of recorded information without deteriorating the performance of the information recording and reproducing device.

The slider 500 can be reduced in size while being mounted with the recording element and the reproducing element. It is possible to reduce manufacturing costs for the information recording and reproducing device.

Note that, in the second embodiment, the metal antenna is used for the recording element to excite Plasmon resonance. The phase change material of the recording films in the cells 105 on the disk 104, which is a patterned medium, is subjected to phase change to record information. The metal antenna is used for the reproducing element to detect a phase state of the phase change material of the recording films in the cells 105 as the level of a Plasmon resonance state to thereby reproduce the information. However, a method of recording or reproducing information and the structure of a disk are not limited to the above. That is, a recording method for the information recording and reproducing device may be a magnetic recording method or the like in which a magnetic element and a magnetic disk used in a hard disk drive are used. In this case, effects same as the effects explained above are obtained.

Note that, in the second embodiment, the heater is used as the inter-element distance varying unit. The distance in the disk radial direction between the recording element and the reproducing element is varied according to heat generation of the heater making use of peripheral expansion and contraction corresponding to a heat value change. However, the present invention is not specifically limited to this. That is, the distance in the disk radial direction between the recording element and the reproducing element may be varied using, for example, a piezoelectric element. In this case, effects same as the effects explained above are obtained.

Note that, in the first and second track positional shift detecting units in the second embodiment, the TE signal is generated from the detection signal obtained when the metal antenna passes the discrete servo area 111 on the disk 104. However, the present invention is not specifically limited to this. That is, for example, a TE signal indicating a positional deviation of the recording element or the reproducing element with respect to the track center may be generated from detection signals continuously obtained in the data area 110. In this case, effects same as the effects explained above are obtained.

Note that, in the second embodiment, a signal is reproduced using the binarizing unit. However, the present invention is not specifically limited to this. That is, for example, a configuration in which a signal is reproduced using, for example, a waveform equalization circuit may be adopted.

Note that, in the second embodiment, the rotating direction of the disk 104 is set in the direction from the lower part on the paper surface to the upper part on the paper surface in FIG. 10. The recording direction of the tracks on the disk 104 is set in the direction from the left on the paper surface to the right on the paper surface in FIG. 10. However, the present invention is not specifically limited to this. That is, the arrangement of the recording element and the reproducing element on the slider only has to be qualitatively the same as the arrangement in the second embodiment with respect to the rotating direction of the disk and the recording direction of the tracks. In this case, effects same as the effects explained above are obtained.

### Third Embodiment

In the third embodiment, an information recording and reproducing device is explained as an example of the information device. A disk is explained as an example of the information carrier. A recording element for recording information on the information carrier is explained as an example of the first element. A reproducing element for reproducing the information from the information carrier is explained as an example of the second element.

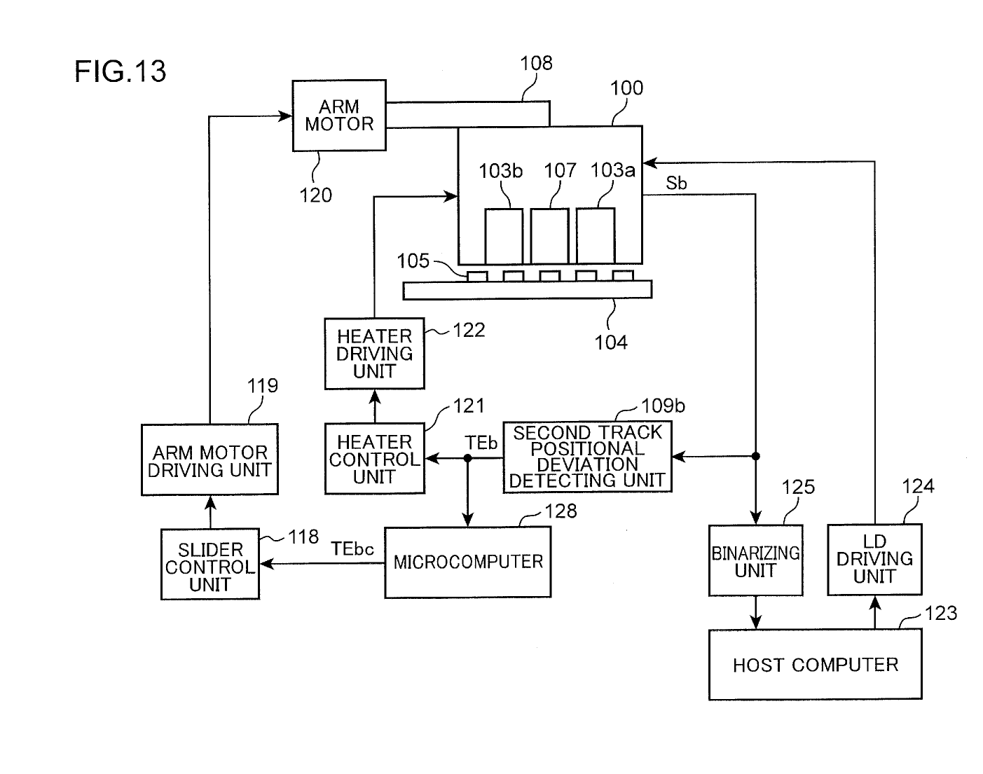

FIG. 13 is a block diagram showing the configuration of an information recording and reproducing device in the third embodiment of the present invention. Note that, in the third embodiment, components same as the components in the first embodiment and the second embodiment are denoted by the same reference numerals and signs and explanation of the components is omitted.

The information recording and reproducing device shown in FIG. 13 includes the slider 100, the suspension arm 108, the second track positional deviation detecting unit 109b, the slider control unit 118, the arm motor driving unit 119, the arm motor 120, the heater control unit 121, the heater driving unit 122, the host computer 123, the LD driving unit 124, the binarizing unit 125, and a microcomputer 128.

The microcomputer 128 estimates a positional deviation between the first metal antenna 103a (the recording element) and the track on the basis of a signal from the second track positional deviation detecting unit 109b. The microcomputer 128 estimates a positional deviation between the first metal antenna 103a (the recording element) and the track on the basis of a radial position of the disk 104 where the slider 100 (the head) is located.

Note that, in the third embodiment, the microcomputer 128 is equivalent to an example of a recording track positional deviation estimating unit.

The operation of the information recording and reproducing device configured as explained above is explained.

The second track positional deviation detecting unit 109b outputs the TE signal TEb indicating a positional deviation between the distal end of the second metal antenna 103b and the track center to the heater control unit 121 and the microcomputer 128. The TE signal TEb indicating the positional deviation between the distal end of the second metal antenna 103b and the track center is input to the heater control unit 121 and the microcomputer 128.

The microcomputer 128 calculates, on the basis of a present disk radial position where the slider 100 is located, a deviation amount representing to which degree the distance between the distal end of the first metal antenna 103a and the distal end of the second metal antenna 103b deviates from the track interval Tp. The microcomputer 128 generates a correction TE signal TEbc by adding an offset to the TE signal TEb according to the calculated deviation amount and outputs the generated correction TE signal TEbc to the slider control unit 118.

According to the operation explained above, even in a configuration in which a TE signal is not obtained from the first metal antenna 103a, track control for controlling the distal end of the first metal antenna 103a to be correctly located in the track center of the disk 104 is realized using the correction TE signal TEbc estimated from the TE signal TEb indicating the positional deviation between the distal end of the second metal antenna 103b and the track center.

The generation of the correction TE signal TEbc in the microcomputer 128 is explained.

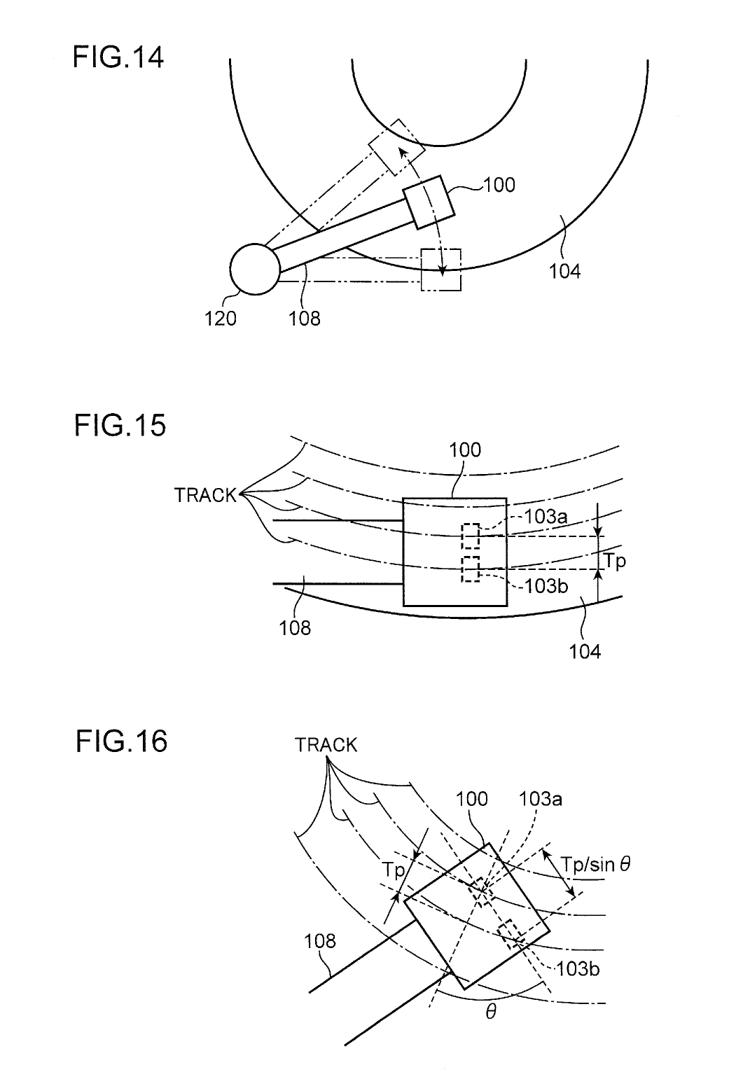

FIG. 14 is a top view showing a state in which the slider is driven in the disk radial direction in the third embodiment. As shown in FIG. 14, the suspension arm 108 moves with the arm motor 120 set as a fulcrum. When the fulcrum of the suspension arm 108 is present on the tangent in the outermost circumference of the disk 104, the slider 100 moves in the disk radial direction while drawing an arcuate track indicated by a broken line in FIG. 14 according to the motion of the suspension arm 108.

FIG. 15 is a schematic diagram showing a relation among the slider 100, the first metal antenna 103a, the second metal antenna 103b, and the tracks of the disk 104 at the time when the slider 100 is located near the outermost circumference of the disk 104. FIG. 16 is a schematic diagram showing a relation among the slider 100, the first metal antenna 103a, the second metal antenna 103b, and the tracks of the disk 104 at the time when the slider 100 is located near the innermost circumference of the disk 104.

As shown in FIG. 15, when the slider 100 is located near the outermost circumference of the disk 104, the fulcrum of the suspension arm 108 is present on the tangent of the outermost circumference of the disk 104. Therefore, when the distal end of the first metal antenna 103a and the distal end of the second metal antenna 103b are caused to respectively follow tracks, the distance between the distal end of the first metal antenna 103a and the distal end of the second metal antenna 103b is equal to the track interval Tp.

On the other hand, as shown in FIG. 16, when the slider 100 is located near the innermost circumference of the disk 104, when the distal end of the first metal antenna 103a and the distal end of the second metal antenna 103b are caused to respectively follow tracks, the distance between the distal end of the first metal antenna 103a and the distal end of the second metal antenna 103b is Tp/sin θ.

Therefore, a deviation amount of the distance between the distal end of the first metal antenna 103a and the distal end of the second metal antenna 103b from the track interval Tp is Tp-Tp/sin θ. As shown in FIG. 16, the angle θ is an angle formed by the tangent of the track and a straight line connecting the distal end of the first metal antenna 103a and the distal end of the second metal antenna 103b. The angle θ changes according to a disk radial position where the slider 100 is located. Therefore, a deviation amount of the distance between the distal end of the first metal antenna 103a and the distal end of the second metal antenna 103b from the track interval Tp can be calculated on the basis of a radial position where the slider 100 is located. Further, the offset added to the TE signal TEb can be calculated using the calculated deviation amount and detection sensitivity of the TE signal TEb.

As explained above, in the information recording and reproducing device in the third embodiment, the microcomputer 128 calculates, on the basis of a radial position of the disk 104 where the slider 100 is located, a deviation amount of the distance between the distal end of the first metal antenna 103a and the distal end of the second metal antenna 103b deviating from the track interval Tp and adds an offset corresponding to the calculated deviation amount to the TE signal TEb to generate the correction TE signal TEbc used for the track control for the first metal antenna 103a.

Therefore, in the information recording and reproducing device in which the recording element and the reproducing element are arranged on one slider and the respective elements are caused to respectively follow tracks, even when the recording track positional deviation detecting unit that detects a positional deviation between the recording element and the track is absent, it is possible to estimate a positional deviation between the recording element and the track with the recording track positional deviation estimating unit (the microcomputer 128) and cause the recording element and the reproducing element to respectively correctly follow tracks according to the track control for the recording element and the track control for the reproducing element. As a result, it is possible to improve recording performance and reproducing performance of the information recording and reproducing device.

Note that, in the third embodiment, the arm motor 120 and the heater 107 cause the recording element and the reproducing element to follow tracks adjacent to each other in the disk radial direction. However, the present invention is not specifically limited to this. The arm motor 120 and the heater 107 may cause the recording element and the reproducing element to follow tracks apart from each other by two or more tracks in the disk radial direction. In this case, effects same as the effects explained above are obtained.

Note that, in the third embodiment, the track control for the first metal antenna 103a (the recording element) is performed by the correction TE signal TEbc and the arm motor 120 (the head moving unit). The track control for the second metal antenna 103b (the reproducing element) is performed by the TE signal TEb and the heater 107 (the inter-element distance varying unit). However, the present invention is not specifically limited to this. The track control for the first metal antenna 103a (the recording element) may be performed by the correction TE signal TEbc and the heater 107 (the inter-element distance varying unit). The track control for the second metal antenna 103b (the reproducing element) may be performed by the TE signal TEb and the arm motor 120 (the head moving unit). In this case, effects same as the effects explained above are obtained.

Note that, in the third embodiment, the metal antenna is used for the recording element to excite Plasmon resonance. The phase change material of the recording films in the cells 105 on the disk 104, which is a patterned medium, is subjected to phase change to record information. The metal antenna is used for the reproducing element to detect a phase state of the phase change material of the recording films in the cells 105 as the level of a Plasmon resonance state to thereby reproduce the information. However, a method of recording or reproducing information and the structure of a disk are not limited to the above. That is, a recording method for the information recording and reproducing device may be a magnetic recording method or the like in which a magnetic element and a magnetic disk used in a hard disk drive are used. In this case, effects same as the effects explained above are obtained.

Note that, in the third embodiment, the heater is used as the inter-element distance varying unit. The distance in the disk radial direction between the recording element and the reproducing element is varied according to heat generation of the heater making use of peripheral expansion and contraction corresponding to a heat value change. However, the present invention is not specifically limited to this. That is, the distance in the disk radial direction between the recording element and the reproducing element may be varied using, for example, a piezoelectric element. In this case, effects same as the effects explained above are obtained.

Note that, in the first and second track positional shift detecting units in the third embodiment, the TE signal is generated from the detection signal obtained when the metal antenna passes the discrete servo area 111 on the disk 104. However, the present invention is not specifically limited to this. That is, for example, a TE signal indicating a positional deviation of the recording element or the reproducing element with respect to the track center may be generated from detection signals continuously obtained in the data area 110. In this case, effects same as the effects explained above are obtained.

Note that, in the third embodiment, a signal is reproduced using the binarizing unit. However, the present invention is not specifically limited to this. That is, for example, a configuration in which a signal is reproduced using, for example, a waveform equalization circuit may be adopted.

Note that, in the third embodiment, the rotating direction of the disk 104 is set in the direction from the lower part on the paper surface to the upper part on the paper surface in FIG. 2. The recording direction of the tracks on the disk 104 is set in the direction from the left on the paper surface to the right on the paper surface in FIG. 2. However, the present invention is not specifically limited to this. The arrangement of the recording element and the reproducing element on the slider only has to be qualitatively the same as the arrangement in the third embodiment with respect to the rotating direction of the disk and the recording direction of the tracks. In this case, effects same as the effects explained above are obtained.

### Fourth Embodiment

In a fourth embodiment, an information recording and reproducing device is explained as an example of the information device. A disk is explained as an example of the information carrier. A recording element for recording information on the information carrier is explained as an example of the first element. A reproducing element for reproducing the information from the information carrier is explained as an example of the second element.

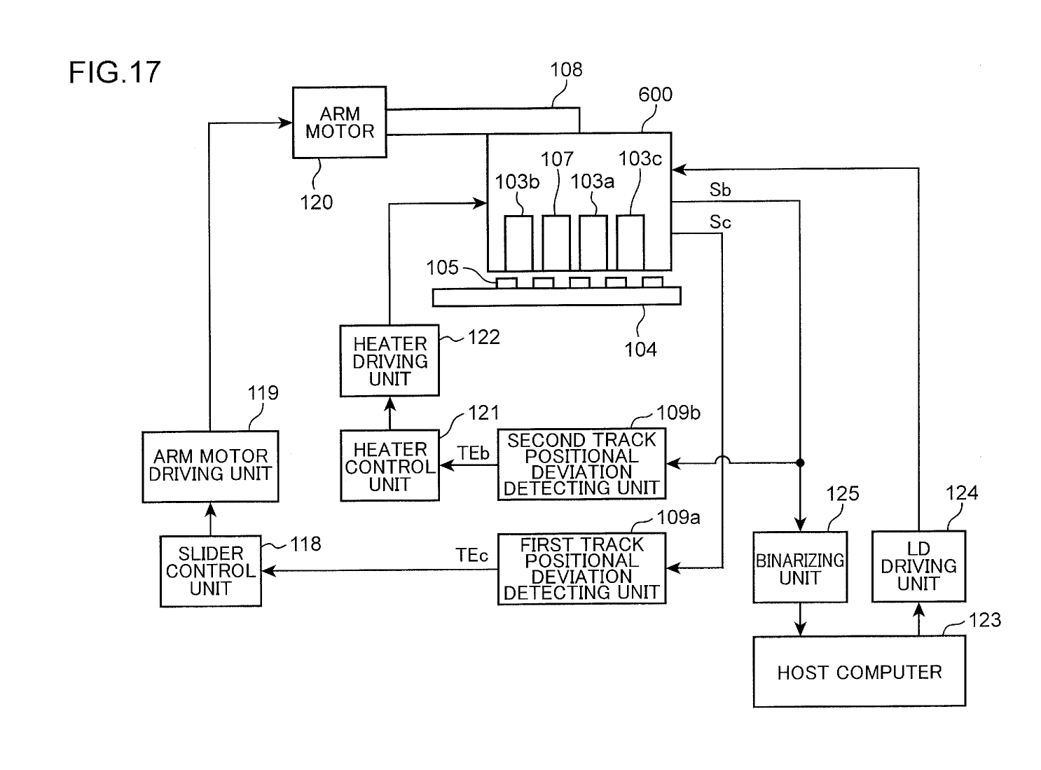

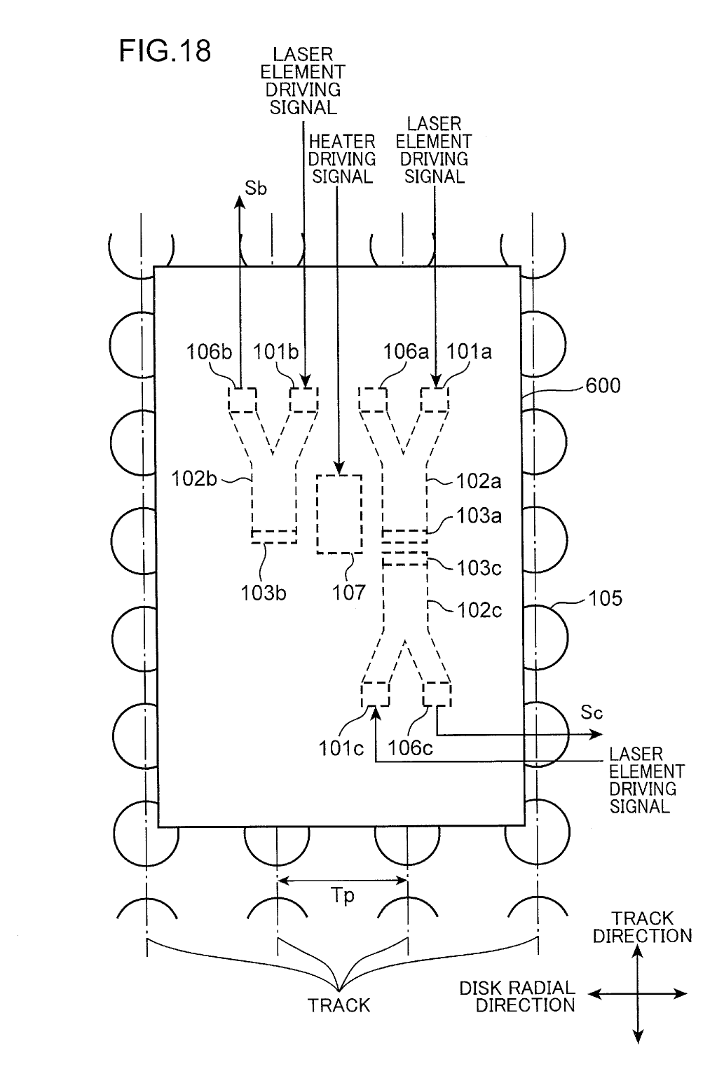

FIG. 17 is a block diagram showing the configuration of an information recording and reproducing device in the fourth embodiment of the present invention. FIG. 18 is a schematic diagram showing an example of the configuration of a slider 600 in FIG. 17. Note that, in the fourth embodiment, components same as the components in the first to third embodiments are denoted by the same reference numerals and signs and explanation of the components is omitted.

The information recording and reproducing device shown in FIG. 17 includes the slider 600, the suspension arm 108, the first track positional deviation detecting unit 109a, the second track positional deviation detecting unit 109b, the slider control unit 118, the arm motor driving unit 119, the arm motor 120, the heater control unit 121, the heater driving unit 122, the host computer 123, the LD driving unit 124, and the binarizing unit 125.

As shown in FIG. 18, the slider 600 includes the first metal antenna 103a having a triangular shape, the second metal antenna 103b having a triangular shape, a third metal antenna 103c having a triangular shape, and the heater 107. The first metal antenna 103a, the second metal antenna 103b, and the third metal antenna 103c are respectively arranged on the slider 600 such that distal ends of the triangular shapes are closest to the surfaces of the cells 105. In addition, the first metal antenna 103a and the second metal antenna 103b are arranged on the slider 600 in the order of the first metal antenna 103a and the second metal antenna 103b from the left on the paper surface such that the distal end of the first metal antenna 103a and the distal end of the second metal antenna 103b are present in positions apart from each other in the disk radial direction by the track interval Tp. The third metal antenna 103c is arranged near the first metal antenna 103a in the track direction to be located on a track in a disk radial position same as the disk radial position of the first metal antenna 103a. The heater 107 is arranged between the first metal antenna 103a and the second metal antenna 103b.

The slider 600 includes the first semiconductor laser element 101a, the second semiconductor laser element 101b, a third semiconductor laser element 101c, the first waveguide 102a, the second waveguide 102b, a third waveguide 102c, the first metal antenna 103a, the second metal antenna 103b, the third metal antenna 103c, the first light receiving element 106a, the second light receiving element 106b, a third light receiving element 106c, and the heater 107.

The third metal antenna 103c is arranged on a track same as the track of the first semiconductor laser element 101a (the recording element) and near the first semiconductor laser element 101a (the recording element). The first track positional deviation detecting unit 109a detects a positional deviation between the third metal antenna 103c (an element for tracking) and the track. The second track positional deviation detecting unit 109b detects a positional deviation between the second metal antenna 103b (the reproducing element) and the track.

Note that, in the fourth embodiment, the third metal antenna 103c is equivalent to an example of the element for tracking. The first track positional deviation detecting unit 109a is equivalent to an example of the recording track positional deviation detecting unit. The second track positional deviation detecting unit 109b is equivalent to an example of the reproducing track positional deviation detecting unit. The slider 600 is equivalent to an example of the head.

The operation of the information recording and reproducing device configured as explained above is explained.

Light emitted from the third semiconductor laser element 101c, which is a light source, is made incident on the third waveguide 102c having a Y shape, which is an optical element that guides light, and guided to the third metal antenna 103c by the third waveguide 102c. The third metal antenna 103c is a resonance element configured to excite Plasmon resonance using the light of the third semiconductor laser element 101c. The light guided to the third metal antenna 103c excites Plasmon resonance.

On the other hand, reflected light from the third metal antenna 103c is made incident on the third waveguide 102c, guided to the third light receiving element 106c by the third waveguide 102c, and detected. The third light receiving element 106c detects a detection signal Sc corresponding to the intensity of the detected reflected light. The detection signal Sc output from the third light receiving element 106c is input to the first track positional deviation detecting unit 109a. The first track positional deviation detecting unit 109a generates, on the basis of the detection signal Sc, a TE signal TEc indicating a positional deviation between the distal end of the third metal antenna 103c having a triangular shape and the track center. The first track positional deviation detecting unit 109a outputs the TE signal TEc indicating the positional deviation between the distal end of the third metal antenna 103c and the track center to the slider control unit 118.

According to the operation explained above, track control for controlling the distal end of the third metal antenna 103c to be correctly located in the track center of the disk 104 is realized using the TE signal TEc.

The third metal antenna 103c is arranged near the first metal antenna 103a in the track direction to be located on a track in a disk radial direction same as the disk radial direction of the first metal antenna 103a, which is the recording element. Therefore, according to the track control by the TE signal TEc, the distal end of the third metal antenna 103c and the distal end of the first metal antenna 103a are controlled to be correctly located in the track center of the same track of the disk 104.

According to the operation explained above, even in a configuration in which a TE signal is not obtained from the first metal antenna 103a, track control for controlling the distal end of the first metal antenna 103a to be correctly located in the track center of the disk 104 is realized using the TE signal TEc obtained from third metal antenna 103c for tracking.

As explained above, in the information recording and reproducing device in the fourth embodiment, the track control for the first metal antenna 103a is performed by the TE signal TEc and the arm motor 120. Consequently, even when a TE signal indicating a positional deviation between the distal end of the first metal antenna 103a and the track center is not obtained in the first metal antenna 103a, which is the recording element, the first metal antenna 103a can correctly follow a track.

Therefore, in the information recording and reproducing device in which the recording element and the reproducing element are arranged on one slider and the respective elements are caused to respectively follow tracks, a positional deviation between the recording element and the track is detected according to a positional deviation between the element for tracking and the track. Therefore, the recording element and the reproducing element can respectively correctly follow tracks according to the track control for the recording element and the track control for the reproducing element. As a result, it is possible to improve the recording performance and the reproducing performance of the information recording and reproducing device.

Note that, in the fourth embodiment, the arm motor 120 and the heater 107 cause the recording element and the reproducing element to follow tracks adjacent to each other in the disk radial direction. However, the present invention is not specifically limited to this. The arm motor 120 and the heater 107 may cause the recording element and the reproducing element to follow tracks apart from each other by two or more tracks in the disk radial direction. In this case, effects same as the effects explained above are obtained.

Note that, in the fourth embodiment, the track control for the first metal antenna 103a (the recording element) is performed by the TE signal TEc and the arm motor 120 (the head moving unit). The track control for the second metal antenna 103b (the reproducing element) is performed by the TE signal TEb and the heater 107 (the inter-element distance varying unit). However, the present invention is not specifically limited to this. The track control for the first metal antenna 103a (the recording element) may be performed by the TE signal TEc and the heater 107 (the inter-element distance varying unit). The track control for the second metal antenna 103b (the reproducing element) may be performed by the TE signal TEb and the arm motor 120 (the head moving unit). In this case, effects same as the effects explained above are obtained.

Note that, in the fourth embodiment, the metal antenna is used for the recording element to excite Plasmon resonance. The phase change material of the recording films in the cells 105 on the disk 104, which is a patterned medium, is subjected to phase change to record information. The metal antenna is used for the reproducing element to detect a phase state of the phase change material of the recording films in the cells 105 as the level of a Plasmon resonance state to thereby reproduce the information. However, a method of recording or reproducing information and the structure of a disk are not limited to the above. That is, a recording method for the information recording and reproducing device may be a magnetic recording method or the like in which a magnetic element and a magnetic disk used in a hard disk drive are used. In this case, effects same as the effects explained above are obtained.

Note that, in the fourth embodiment, the heater is used as the inter-element distance varying unit. The distance in the disk radial direction between the recording element and the reproducing element is varied according to heat generation of the heater making use of peripheral expansion and contraction corresponding to a heat value change. However, the present invention is not specifically limited to this. That is, the distance in the disk radial direction between the recording element and the reproducing element may be varied using, for example, a piezoelectric element. In this case, effects same as the effects explained above are obtained.

Note that, in the first and second track positional shift detecting units in the fourth embodiment, the TE signal is generated from the detection signal obtained when the metal antenna passes the discrete servo area 111 on the disk 104. However, the present invention is not specifically limited to this. That is, for example, a TE signal indicating a positional deviation of the recording element or the reproducing element with respect to the track center may be generated from detection signals continuously obtained in the data area 110. In this case, effects same as the effects explained above are obtained.

Note that, in the fourth embodiment, a signal is reproduced using the binarizing unit. However, the present invention is not specifically limited to this. That is, for example, a configuration in which a signal is reproduced using, for example, a waveform equalization circuit may be adopted.

Note that, in the fourth embodiment, the rotating direction of the disk 104 is set in the direction from the lower part on the paper surface to the upper part on the paper surface in FIG. 18. The recording direction of the tracks on the disk 104 is set in the direction from the left on the paper surface to the right on the paper surface in FIG. 18. However, the present invention is not specifically limited to this. That is, the arrangement of the recording element and the reproducing element on the slider only has to be qualitatively the same as the arrangement in the fourth embodiment with respect to the rotating direction of the disk and the recording direction of the tracks. In this case, effects same as the effects explained above are obtained.

### Fifth Embodiment

In a fifth embodiment, an information recording and reproducing device is explained as an example of the information device. A disk is explained as an example of the information carrier. A recording element for recording information on the information carrier is explained as an example of the first element. A reproducing element for reproducing the information from the information carrier is explained as an example of the second element.

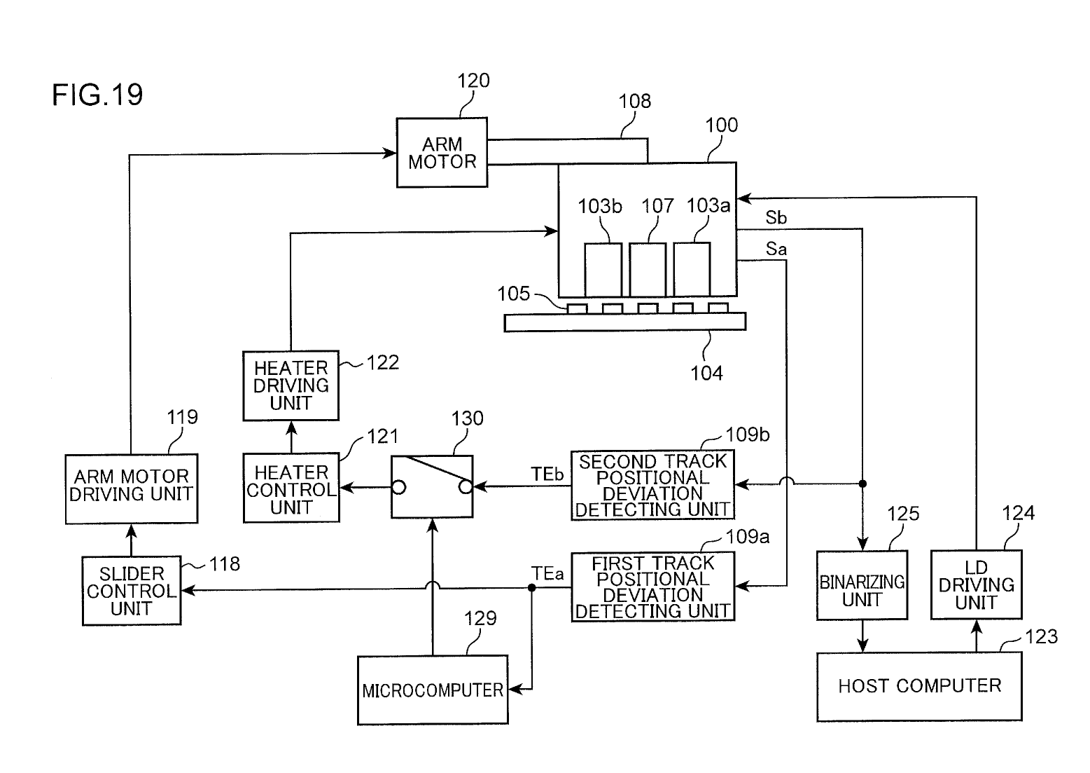

FIG. 19 is a block diagram showing the configuration of an information recording and reproducing device in the fifth embodiment of the present invention. Note that, in the fifth embodiment, components same as the components in the first to fourth embodiments are denoted by the same reference numerals and signs and explanation of the components is omitted.

The information recording and reproducing device shown in FIG. 19 includes the slider 100, the suspension arm 108, the first track positional deviation detecting unit 109a, the second track positional deviation detecting unit 109b, the slider control unit 118, the arm motor driving unit 119, the arm motor 120, the heater control unit 121, the heater driving unit 122, the host computer 123, the LD driving unit 124, the binarizing unit 125, a microcomputer 129, and a switch 130.

The microcomputer 129 detects, on the basis of a signal from the first track positional deviation detecting unit 109a during the recording operation, whether an abnormality has occurred during the recording operation.

When it is detected by the microcomputer 129 that an abnormality has occurred during the recording operation, the switch 130 stops the second metal antenna 103b (the reproducing element) from following a target track.

Note that, in the fifth embodiment, the microcomputer 129 is equivalent to an example of a recording abnormality detecting unit. The switch 130 is equivalent to an example of a following stopping unit.

The operation of the information recording and reproducing device configured as explained above is explained.

The first track positional deviation detecting unit 109a outputs the TE signal TEa indicating a positional deviation between the distal end of the first metal antenna 103a and the track center to the slider control unit 118 and the microcomputer 129. The TE signal TEa indicating the positional deviation between the distal end of the first metal antenna 103a and the track center is input to the slider control unit 118 and the microcomputer 129.

On the other hand, the second track positional deviation detecting unit 109b outputs the TE signal TEb indicating a positional deviation between the distal end of the first metal antenna 103a and the track center to the switch 130. The TE signal TEb indicating the positional deviation between the distal end of the first metal antenna 103a and the track center is input to the heater control unit 121 through the switch 130.

The microcomputer 129 determines on the basis of the input TE signal TEa whether a control abnormality has occurred during the recording operation. Note that the microcomputer 129 compares the TE signal TEa output from the first track positional deviation detecting unit 109a and a predetermined threshold. When the TE signal TEa does not exceed the predetermined threshold, the microcomputer 129 determines that a control abnormality has not occurred during the recording operation and the recording operation is normally performed. When the TE signal TEa exceeds the predetermined threshold, the microcomputer 129 determines that a control abnormality has occurred during the recording operation. When determining that a control abnormality has occurred during the recording operation, the microcomputer 129 outputs a control signal to the switch 130 and turns off the switch 130.

According to the operation explained above, the microcomputer 129 determines, using the TE signal TEa, whether a control abnormality has occurred during the recording operation. When it is determined that a control abnormality has occurred, the microcomputer 129 turns off the switch 130. Consequently, the track control for controlling, with the TE signal TEb and the heater 107, the distal end of the second metal antenna 103b to be correctly located in the track center is stopped.

Consequently, in the information recording and reproducing device in the fifth embodiment, when a control abnormality occurs during a verify operation for reproducing, with the second metal antenna 103b, in parallel to recording of information by the first metal antenna 103a, after the disk 104 rotates once, the recorded information to thereby check whether information has been correctly recorded, it is possible to preferentially execute track control in the recording element.

Therefore, in the information recording and reproducing device in which the recording element and the reproducing element are arranged on one slider and the respective elements are caused to respectively follow tracks, when a control abnormality occurs during the recording operation, it is possible to stop the track control in the reproducing element and cause only the track control in the recording element to operate. As a result, it is possible to improve the recording performance of the information recording and reproducing device.

Note that, in the fifth embodiment, the arm motor 120 and the heater 107 cause the recording element and the reproducing element to follow tracks adjacent to each other in the disk radial direction. However, the present invention is not specifically limited to this. The arm motor 120 and the heater 107 may cause the recording element and the reproducing element to follow tracks apart from each other by two or more tracks in the disk radial direction. In this case, effects same as the effects explained above are obtained.

Note that, in the fifth embodiment, the track control for the first metal antenna 103a (the recording element) is performed by the TE signal TEa and the arm motor 120 (the head moving unit). The track control for the second metal antenna 103b (the reproducing element) is performed by the TE signal TEb and the heater 107 (the inter-element distance varying unit). However, the track control for the first metal antenna 103a (the recording element) may be performed by the TE signal TEa and the heater 107 (the inter-element distance varying unit). The track control for the second metal antenna 103b (the reproducing element) may be performed by the TE signal TEb and the arm motor 120 (the head moving unit). In this case, effects same as the effects explained above are obtained.

Note that, in the fifth embodiment, the metal antenna is used for the recording element to excite Plasmon resonance. The phase change material of the recording films in the cells 105 on the disk 104, which is a patterned medium, is subjected to phase change to record information. The metal antenna is used for the reproducing element to detect a phase state of the phase change material of the recording films in the cells 105 as the level of a Plasmon resonance state to thereby reproduce the information. However, a method of recording or reproducing information and the structure of a disk are not limited to the above. That is, a recording method for the information recording and reproducing device may be a magnetic recording method or the like in which a magnetic element and a magnetic disk used in a hard disk drive are used. In this case, effects same as the effects explained above are obtained.

Note that, in the fifth embodiment, the heater is used as the inter-element distance varying unit. The distance in the disk radial direction between the recording element and the reproducing element is varied according to heat generation of the heater making use of peripheral expansion and contraction corresponding to a heat value change. However, the present invention is not specifically limited to this. That is, the distance in the disk radial direction between the recording element and the reproducing element may be varied using, for example, a piezoelectric element. In this case, effects same as the effects explained above are obtained.

Note that, in the first and second track positional shift detecting units in the fifth embodiment, the TE signal is generated from the detection signal obtained when the metal antenna passes the discrete servo area 111 on the disk 104. However, the present invention is not specifically limited to this. That is, for example, a TE signal indicating a positional deviation of the recording element or the reproducing element with respect to the track center may be generated from detection signals continuously obtained in the data area 110. In this case, effects same as the effects explained above are obtained.

Note that, in the fifth embodiment, a signal is reproduced using the binarizing unit. However, the present invention is not specifically limited to this. That is, for example, a configuration in which a signal is reproduced using, for example, a waveform equalization circuit may be adopted.

Note that, in the fifth embodiment, the rotating direction of the disk 104 is set in the direction from the lower part on the paper surface to the upper part on the paper surface in FIG. 2. The recording direction of the tracks on the disk 104 is set in the direction from the left on the paper surface to the right on the paper surface in FIG. 2. However, the present invention is not specifically limited to this. The arrangement of the recording element and the reproducing element on the slider only has to be qualitatively the same as the arrangement in the fifth embodiment with respect to the rotating direction of the disk and the recording direction of the tracks. In this case, effects same as the effects explained above are obtained.

### Sixth Embodiment

In a sixth embodiment, an information recording and reproducing device is explained as an example of the information device. A magnetic disk is explained as an example of the information carrier. An element for tracking is explained as an example of the first element. A heating element for heating a recording target area of the information carrier is explained as an example of the second element.

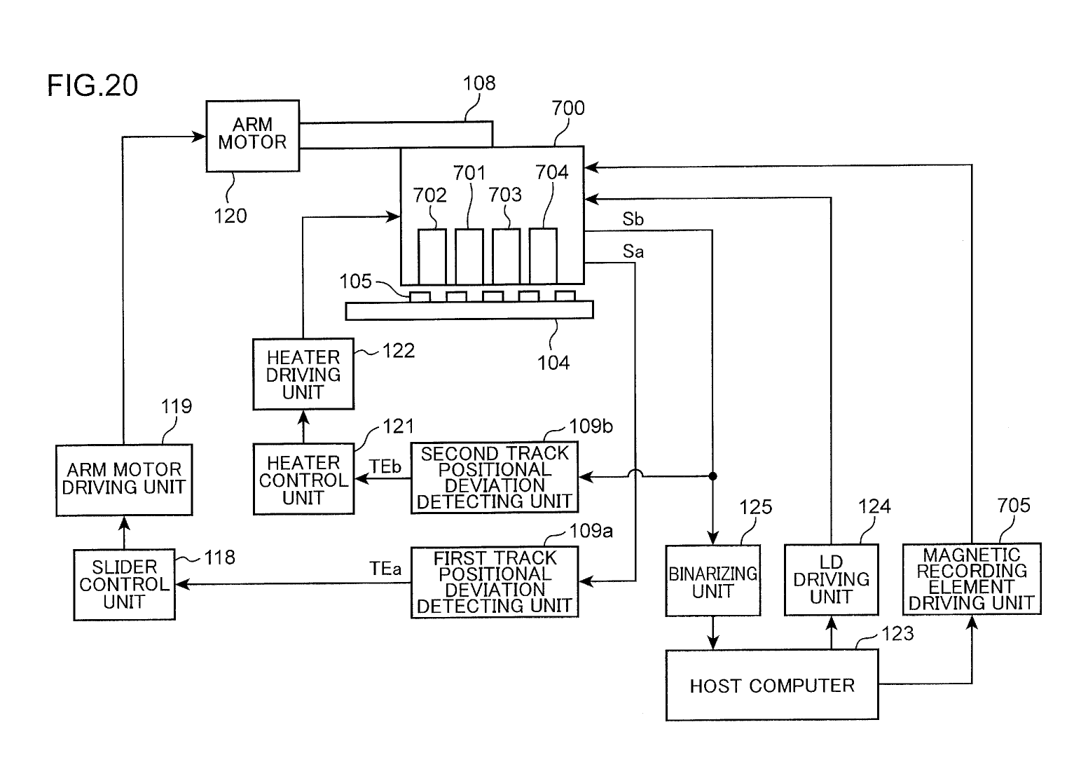

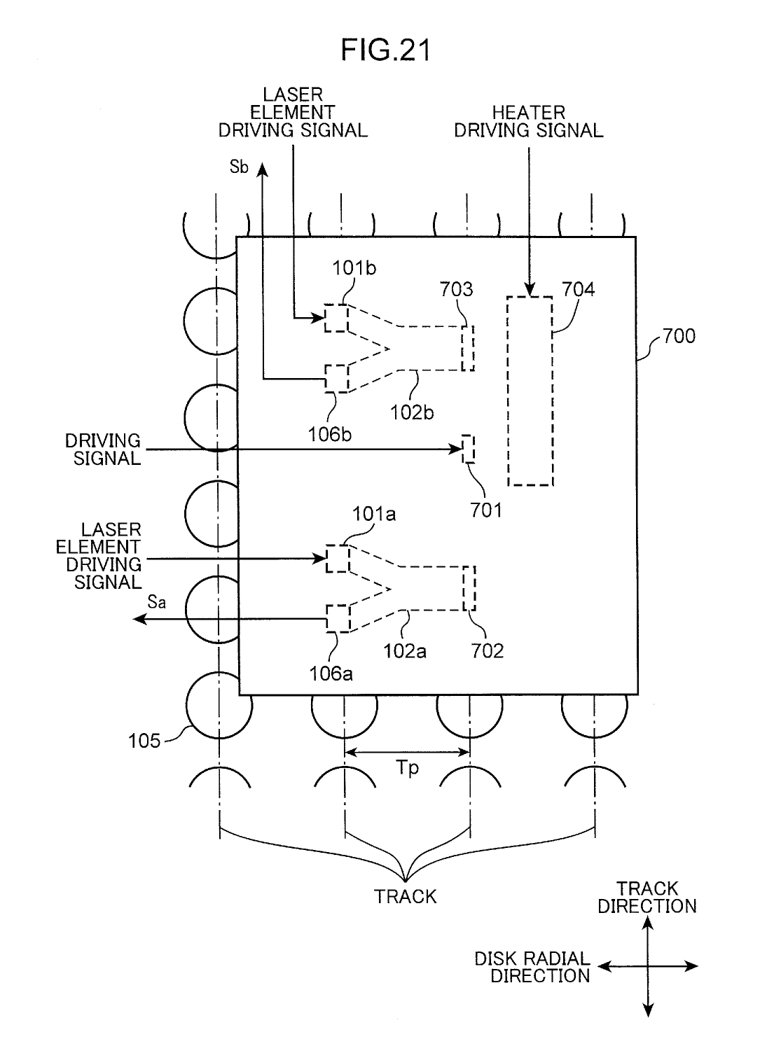

FIG. 20 is a block diagram showing the configuration of an information recording and reproducing device in the sixth embodiment of the present invention. FIG. 21 is a schematic diagram showing an example of the configuration of a slider 700 in FIG. 20. Note that, in the sixth embodiment, components same as the components in the first embodiment are denoted by the same reference numerals and signs and explanation of the components is omitted.

The information recording and reproducing device shown in FIG. 20 includes the slider 700, the suspension arm 108, the first track positional deviation detecting unit 109a, the second track positional deviation detecting unit 109b, the slider control unit 118, the arm motor driving unit 119, the arm motor 120, the heater control unit 121, the heater driving unit 122, the host computer 123, the LD driving unit 124, the binarizing unit 125, and a magnetic recording element driving unit 705.

As shown in FIG. 21, the slider 700 includes a magnetic recording element 701, a heating element 702, an element for tracking 703, and a heater 704.

The magnetic recording element 701, the heating element 702, and the element for tracking 703 are arranged on the slider 700 such that the distal ends thereof are closest to the surfaces of the cells 105. In addition, the magnetic recording element 701, the heating element 702, and the element for tracking 703 are arranged on the slider 700 in the order of the element for tracking 703, the magnetic recording element 701, and the heating element 702 from the upper part on the paper surface such that the distal ends thereof are located on tracks in the same disk radial direction a predetermined distance apart from one another. That is, the magnetic recording element 701, the heating element 702, and the element for tracking 703 are arranged on the same head such that the heating element 702 reaches a position where information is recorded on the disk and then the magnetic recording element 701 and the element for tracking 703 reach the position. The heater 704 is arranged in the disk radial direction with respect to the magnetic recording element 701 and the element for tracking 703.

The slider 700 further includes the first semiconductor laser element 101a, the second semiconductor laser element 101b, the first waveguide 102a, the second waveguide 102b, the first light receiving element 106a, and the second light receiving element 106b.

The heating element 702 is configured by a metal antenna having a triangular shape and emits near field light. The heating element 702 heats a recording target area of the disk 104. The cells 105 include a magnetic recording material. The host computer 123 outputs a recording data signal to the magnetic recording element driving unit 705. The magnetic recording element driving unit 705 outputs a driving signal to the magnetic recording element 701 according to the input recording data signal. The magnetic recording element 701 generates a magnetic field according to the driving signal from the magnetic recording element driving unit 705. The magnetic recording element 701 magnetically records information on the disk 104.

The magnetic recording device in the sixth embodiment records, with the magnetic field generated by the magnetic recording element 701, information in the cell 105 heated by being irradiated with the near field light by the heating element 702.

That is, when the near field light from the heating element 702 is irradiated on the cell 105 and the cell 105 is heated, the coercive force of the cell 105 temporarily falls. Making use of the fall in the coercive force, information is recorded in the cell 105, the coercive force of which falls, by changing the magnetic pole or the like of the cell 105 with the magnetic field generated by the magnetic recording element 701.

The element for tracking 703 is configured by a metal antenna having a triangular shape and causes Plasmon resonance between the element for tracking 703 and the cell 105. The element for tracking 703 is arranged on a track same as the track of the magnetic recording element 701 and near the magnetic recording element 701. Therefore, the magnetic recording element 701 is located on a track same as the track of the element for tracking 703.

The first track positional deviation detecting unit 109a generates, on the basis of the detection signal Sa from the first light receiving element 106a, the TE signal TEa indicating a positional deviation between the distal end of the heating element 702 and the track center. The second track positional deviation detecting unit 109b generates, on the basis of the detection signal Sb from the second light receiving element 106b, the TE signal TEb indicating a positional deviation between the distal end of the element for tracking 703 and the track center.

The TE signal TEa is input to the slider control unit 118. The slider 700 is moved in the disk radial direction. Consequently, track control for controlling the distal end of the heating element 702 to be correctly located in the track center of the disk 104 is realized using the TE signal TEa.

On the other hand, the TE signal TEb is input to the heater control unit 121. The heater 704 generates heat according to a heater driving signal and changes the distances between the heating element 702 and the element for tracking 703 and the magnetic recording element 701 according to peripheral expansion and contraction corresponding to a heat quantity change. The arm motor 120 and the heater 704 cause the element for tracking 703 and the heating element 702 to follow the same track to thereby cause the magnetic recording element 701 and the heating element 702 to follow the same track. Consequently, the magnetic recording element 701 is moved in the disk radial direction with respect to the heating element 702. Consequently, track control for controlling the distal end of the magnetic recording element 701 to be correctly located in the track center of the disk 104 is realized using the TE signal TEb.

Note that, in the sixth embodiment, the element for tracking 703 is equivalent to an example of the first element and the element for tracking. The heating element 702 is equivalent to an example of the second element and the heating element. The slider 700 is equivalent to an example of the head. The heater 704 is equivalent to an example of the inter-element distance varying unit.

As explained above, the magnetic recording device in the sixth embodiment includes the slider 700 (the head) configured to move on the surface of the disk 104 (the information carrier). The tracks are formed on the surface of the disk 104 along the track direction. The element for tracking 703 (the first element) and the heating element 702 (the second element) for heating a recording target area of the disk 104 are arranged on the same slider 700. The magnetic recording device includes the slider 700 (the head) including the element for tracking 703 (the first element), the heating element 702 (the second element), and the heater 704 (the inter-element distance varying unit) configured to vary the distance between the element for tracking 703 and the heating element 702 in a direction orthogonal to the tracking direction on the surface of the disk 104 and the arm motor 120 (the head moving unit) configured to move the slider 700 in parallel to the surface of the disk 104. The arm motor 120 and the heater 704 cause the element for tracking 703 and the heating element 702 to respectively follow corresponding target tracks.

Further, the slider 700 (the head) includes the magnetic recording element 701 for magnetically recording information on the disk 104. The element for tracking 703 is arranged on a track same as the track of the magnetic recording element 701 and near the magnetic recording element 701. Since the element for tracking 703 and the heating element 702 follow the same track, the magnetic recording element 701 and the heating element 702 follow the same track.

With the configuration explained above, even when the heating element 702 and the magnetic recording element 701 in the slider 700 are not located on the same track because of an assembly error or the like of the magnetic recording device, it is possible to locate the heating element 702 and the magnetic recording element 701 on the same track by locating the heating element 702 and the element for tracking 703 on the same track using the arm motor 120 (the head moving unit) and the heater 704 (the inter-element distance varying unit). Consequently, it is possible to accurately heat, with the heating element 702, a recording target area recorded by the magnetic recording element 701.

Note that, in the sixth embodiment, the track control for the element for tracking 703 may be performed by the TE signal TEa and the heater 704 (the inter-element distance varying unit). The track control for the heating element 702 may be performed by the TE signal TEb and the arm motor 120 (the head moving unit). In this case, effects same as the effects explained above are obtained.

Note that a piezoelectric element or the like may be used as the inter-element distance varying unit in the sixth embodiment.

Note that the recording element in the first to fifth embodiments may be an element configured to record information by irradiating the recording target area of the information carrier with near field light generated by Plasmon resonance with the recording target area. The reproducing element in the first to fifth embodiments may be an element configured to reproduce information by utilizing Plasmon resonance with the reproduction target area of the information carrier.

When the recording element, the reproducing element, the element for tracking, the heating element, and the like are elements that make use of Plasmon resonance, since the elements themselves generate heat, the positions of the elements on the head tend to change. Therefore, as explained in the first to sixth embodiments, since the information device includes the inter-element distance varying unit, it is possible to correct a positional deviation due to the heat generated by the elements themselves.

That is, for example, when the interval between two elements is reduced by heat generated by the two elements themselves, it is possible to correct the interval between the two elements to an appropriate interval by increasing the interval between the two elements with the inter-element distance varying unit. On the other hand, when the interval between two elements is increased by heat generated by the two elements themselves, it is possible to correct the interval between the two elements to the appropriate interval by reducing the interval between the two elements with the inter-element distance varying unit.

Note that, when the inter-element distance varying unit is a heater, for example, the heater may be caused to generate heat in advance and, when the interval between the two elements increases, the interval between the two elements may be reduced by reducing the heat generated from the heat.

Note that the shape of the information carrier in the first to sixth embodiments is not limited to the disk shape (a disc shape). For example, the information carrier may be a flat plate having a square shape. The information carrier may be fixed without being rotated. In this case, the information device may further include a mechanism for moving the head such that the head scans the fixed information carrier.

Note that inventions including configurations explained below are mainly included in the specific embodiments explained above.

An information device according to an aspect of the present invention includes: a head including a first element, a second element, and an inter-element distance varying unit configured to vary the distance between the first element and the second element in a direction orthogonal to a track direction on the surface of the information carrier; and a head moving unit configured to move the head in parallel to the surface of the information carrier. The head moving unit and the inter-element distance varying unit cause the first element and the second element to respectively follow corresponding target tracks.

With this configuration, the first element and the second element are caused to respectively follow the corresponding target tracks by the head moving unit and the inter-element distance varying unit. Therefore, it is possible to cause the respective elements on the head to respectively accurately follow target tracks on the information carrier. Further, it is possible to improve recording performance and reproducing performance.

In the information device, it is preferable that the head moving unit and the inter-element distance varying unit cause the first element and the second element to follow tracks in different radial positions.

With this configuration, the first element and the second element are caused to follow the tracks in the different radial positions. Therefore, it is possible to perform recording of information and reproduction of information in parallel, reproduce, while recording information, the recorded information, and record, while reproducing information, the reproduced information.

In the information device, it is preferable that the head moving unit and the inter-element distance varying unit cause the first element and the second element to follow tracks adjacent to each other in the direction orthogonal to the track direction.

With this configuration, the first element and the second element are caused to follow the tracks adjacent to each other in the direction orthogonal to the track direction. Therefore, it is possible to reduce the size of the head including the first element and the second element and reduce manufacturing costs for the device.

In the information device, it is preferable that the head moving unit and the inter-element distance varying unit cause the first element and the second element to follow the same track.

With this configuration, the first element and the second element are caused to follow the same track. Therefore, it is possible to perform recording of information and reproduction of information in parallel, reproduce, while recording information, the recorded information, and record, while reproducing information, the reproduced information.

In the information device, it is preferable that the first element includes a recording element for recording information on the information carrier, and the second element includes a reproducing element for reproducing the information from the information carrier.

With this configuration, it is possible to record, with the recording element, information on the information carrier and reproduce, with the reproducing element, the information from the information carrier.

In the information device, it is preferable that the recording element irradiates a recording target area of the information carrier with near field light generated by Plasmon resonance with the recording target area to record information on the information carrier, and the reproducing element reproduces the information from the information carrier by utilizing Plasmon resonance with a reproduction target area of the information carrier.

With this configuration, information is recorded on the information carrier by irradiating the recording target area with near field light, and the information is reproduced from the information carrier by utilizing Plasmon resonance. Therefore, it is possible to record information on an information carrier having high recording density and reproduce the information from the information carrier having the high recording density.

In the information device, it is preferable that the recording element and the reproducing element are arranged such that, when a recording operation or a reproducing operation is performed, the recording element reaches a position where information on the information carrier is recorded or reproduced and then the reproducing element reaches the position.

With this configuration, the recording element and the reproducing element are arranged such that, when the recording operation or the reproducing operation is performed, the recording element reaches the position where information on the information carrier is recorded or reproduced and then the reproducing element reaches the position.

Therefore, since it is possible to reproduce, while recording information, the recorded information, it is possible to perform a verify operation simultaneously with the recording operation, reduce time required for the verify operation, and improve recording reliability.

In the information device, it is preferable that the recording element and the reproducing element are arranged apart from each other by a distance equal to or larger than a distance determined on the basis of the number of revolutions of the information carrier and time from start to end of a change of a recording film of the information carrier at the time when the recording operation is performed.

With this configuration, the recording element and the reproducing element are arranged apart from each other by the distance equal to or larger than the distance determined on the basis of the number of revolutions of the information carrier and the time from the start to the end of the change of the recording film of the information carrier at the time when the recording operation is performed. Therefore, it is possible to surely reproduce, after information is recorded, the recorded information.

It is preferable that the information device further includes a checking unit configured to reproduce, with the reproducing element, information recorded by the recording element in parallel to the recording operation to thereby check whether the recording by the recording element has been correctly performed.

With this configuration, the information recorded by the recording element is reproduced in parallel to the recording operation, whereby it is checked whether the recording by the recording element is correctly performed. Therefore, it is possible to perform the verify operation simultaneously with the recording operation, reduce time required for the verify operation, and improve recording reliability.

In the information device, it is preferable that the recording element and the reproducing element are arranged such that, when a recording operation or a reproducing operation is performed, the reproducing element reaches a position where information on the information carrier is recorded or reproduced and then the recording element reaches the position.

With this configuration, the recording element and the reproducing element are arranged such that, when the recording operation or the reproducing operation is performed, the reproducing element reaches the position where information on the information carrier is recorded or reproduced and then the recording element reaches the position.

Therefore, since it is possible to record, while reproducing information, the reproduced information, it is possible to perform, simultaneously with the reproducing operation, an overwriting operation for recording again information recorded in the past, reduce time required for the overwriting operation, and improve reliability of recorded information.

In the information device, it is preferable that the recording element and the reproducing element are arranged apart from each other by a distance equal to or larger than a distance determined on the basis of the number of revolutions of the information carrier, and a total time of a reproduction delay time required for a reproducing signal to pass a reproducing signal transmission line through which the reproducing signal is transmitted, a circuit delay time required for processing the reproducing signal, and a recording delay time required for a recording signal to pass a recording signal transmission line through which the recording signal is transmitted.

With this configuration, the recording element and the reproducing element are arranged apart from each other by the distance equal to or larger than the distance determined on the basis of the number of revolutions of the information carrier, and the total time of the reproduction delay time required for the reproducing signal to pass the reproducing signal transmission line through which the reproducing signal is transmitted, the circuit delay time required for processing the reproducing signal, and the recording delay time required for the recording signal to pass the recording signal transmission line through which the recording signal is transmitted.

Therefore, it is possible to surely record, after reproducing information, the reproduced information.

It is preferable that the information device further includes an overwrite processing unit configured to record, with the recording element, information reproduced by the reproducing element in parallel to the reproducing operation to thereby overwrite information recorded on the information carrier.

With this configuration, the information reproduced by the reproducing element is recorded by the recording element in parallel to the reproducing operation, whereby the information recorded on the information carrier is overwritten. Therefore, it is possible to perform, simultaneously with the reproducing operation, an overwriting operation for recording again information recorded in the past, reduce time required for the overwriting operation, and improve reliability of recorded information.

It is preferable that the information device further includes: a reproducing signal quality measuring unit configured to measure signal quality of a reproducing signal obtained when the information recorded on the information carrier is reproduced; and a recording quality determining unit configured to reproduce, with the reproducing element, the information recorded on the information carrier, and determine recording quality of the information recorded on the information carrier on the basis of a measurement result from the reproducing signal quality measuring unit, and, when it is determined by the recording quality determining unit that the recording quality is poor, the overwrite processing unit records, with the recording element and in parallel to the reproducing operation, the information reproduced by the reproducing element in a position where the information is recorded on the information carrier to thereby overwrite the information recorded on the information carrier.

With this configuration, signal quality of the reproducing signal obtained when the information recorded in the information carrier is reproduced is measured by the reproducing signal quality measuring unit. The information recorded on the information carrier is reproduced by the reproducing element and recording quality of the information recorded on the information carrier is determined by the recording quality determining unit on the basis of the measurement result from the reproducing signal quality measuring unit. When it is determined by the recording quality determining unit that the recording quality is poor, in parallel to the reproducing operation, the information reproduced by the reproducing element is recorded by the recording element in the position where the information is recorded on the information carrier, whereby the information recorded on the information carrier is overwritten by the overwrite processing unit.

Therefore, when the recording quality of the information recorded on the information carrier is poor, the information recorded on the information carrier is overwritten. Therefore, it is possible to improve reliability of recorded information.

It is preferable that the information device further includes: a recording track positional deviation detecting unit configured to detect a positional deviation between the recording element and the track; and a reproducing track positional deviation detecting unit configured to detect a positional deviation between the reproducing element and the track.

With this configuration, the positional deviation between the recording element and the track is detected and the positional deviation between the reproducing element and the track is detected. Therefore, it is possible to cause the recording element and the reproducing element to respectively accurately follow tracks.

It is preferable that the information device further includes: a reproducing track positional deviation detecting unit configured to detect a positional deviation between the reproducing element and the track; and a recording track positional deviation estimating unit configured to estimate a positional deviation between the recording element and the track on the basis of a signal from the reproducing track positional deviation detecting unit.

With this configuration, the positional deviation between the reproducing element and the track is detected by the reproducing track positional deviation detecting unit and the positional deviation between the recording element and the track is estimated by the recording track positional deviation estimating unit on the basis of the signal from the reproducing track positional deviation detecting unit.

Therefore, since the positional deviation between the recording element and the track is estimated on the basis of the positional deviation between the reproducing element and the track, even when the positional deviation between the recording element and the track is not detected, it is possible to cause the recording element to accurately follow the track.

In the information device, it is preferable that the recording track positional deviation estimating unit estimates the positional deviation between the recording element and the track on the basis of a radial position of the information carrier where the head is located.

With this configuration, since the positional deviation of the recording element and the track is estimated on the basis of the radial position of the information carrier where the head is located, even when the positional deviation between the recording element and the track is not detected, it is possible to cause the recording element to accurately follow the track.

In the information device, it is preferable that the head further includes an element for tracking arranged on a track same as the track of the recording element and near the recording element, and the information device further includes: a recording track positional deviation detecting unit configured to detect a positional deviation between the element for tracking and the track; and a reproducing track positional deviation detecting unit configured to detect a positional deviation between the reproducing element and the track.

With this configuration, the head further includes the element for tracking arranged on the track same as the track of the recording element and near the recording element. The positional deviation between the element for tracking and the track is detected by the recording track positional deviation detecting unit and the positional deviation between the reproducing element and the track is detected by the reproducing track positional deviation detecting unit.

Therefore, the positional deviation between the element for tracking, which is arranged on the track same as the track of the recording element and near the recording element, and the track is detected and the element for tracking is caused to follow the track. Consequently, it is possible to cause the recording element to follow the track and, even when the positional deviation between the recording element and the track is not detected, it is possible to cause the recording element to accurately follow the track.

It is preferable that the information device further includes: a recording track positional deviation detecting unit configured to detect a positional deviation between the recording element and the track; a recording abnormality detecting unit configured to detect whether an abnormality has occurred during a recording operation on the basis of a signal from the recording track positional deviation detecting unit during the recording operation; and a following stopping unit configured to stop the reproducing element from following the target track when it is detected by the recording abnormality detecting unit that an abnormality has occurred during the recording operation.

With this configuration, when it is detected that an abnormality has occurred during the recording operation, the track control for the reproducing element is stopped and only the track control for the recording element is performed. Therefore, it is possible to improve recording performance.

In the information device, it is preferable that the head further includes a magnetic recording element for magnetically recording information on the information carrier, the first element includes an element for tracking, the second element includes a heating element for heating a recording target area of the information carrier, the element for tracking is arranged on a track same as the track of the magnetic recording element and near the magnetic recording element, and the head moving unit and the inter-element distance varying unit cause the element for tracking and the heating element to follow the same track to thereby cause the magnetic recording element and the heating element to follow the same track.

With this configuration, the head further includes the magnetic recording element for magnetically recording information on the information carrier. The first element includes the element for tracking and the second element includes the heating element for heating the recording target area of the information carrier. The element for tracking is arranged on the track same as the track of the magnetic recording element and near the magnetic recording element. The head moving unit and the inter-element distance varying unit cause the element for tracking and the heating element to follow the same track to thereby cause the magnetic recording element and the heating element to follow the same track.

Therefore, the element for tracking and the heating element are caused to follow the same track, whereby the magnetic recording element and the heating element are caused to follow the same track. Therefore, it is possible to accurately heat, with the heating element, the recording target area recorded by the magnetic recording element.

Note that the specific embodiments or examples described in the section of the Description of Embodiments only clarify the technical contents of the present invention, should not be interpreted in a narrow sense to be limited to such specific examples, and can be variously changed and carried out within the scope of the spirit of the present invention and the claimed matters.

### INDUSTRIAL APPLICABILITY

The information device according to the present invention is useful for an information device that can cause respective elements on a head to respectively accurately follow target tracks, can improve recording performance and reproducing performance, and records information in an information carrier or reproduces the information from the information carrier.

Therefore, it is possible to use the information device for a large-capacity optical disk recorder, a memory device for a computer, and the like, which are applied equipment of the information device.

1. An information device comprising:
a head including a first element, a second element, and an inter-element distance varying unit configured to vary a distance between the first element and the second element in a direction orthogonal to a track direction on a surface of an information carrier, and
a head moving unit configured to move the head in parallel to the surface of the information carrier, wherein
the head moving unit and the inter-element distance varying unit cause the first element and the second element to respectively follow corresponding target tracks.

2. The information device according to claim 1, wherein the head moving unit and the inter-element distance varying unit cause the first element and the second element to follow tracks in different radial positions.

3. The information device according to claim 2, wherein the head moving unit and the inter-element distance varying unit cause the first element and the second element to follow tracks adjacent to each other in the direction orthogonal to the track direction.

4. The information device according to claim 1, wherein the head moving unit and the inter-element distance varying unit cause the first element and the second element to follow a same track.

5. The information device according to claim 1, wherein
the first element includes a recording element for recording information on the information carrier, and
the second element includes a reproducing element for reproducing the information from the information carrier.

6. The information device according to claim 5, wherein
the recording element irradiates a recording target area of the information carrier with near field light generated by Plasmon resonance with the recording target area to record information on the information carrier, and
the reproducing element reproduces the information from the information carrier by utilizing Plasmon resonance with a reproduction target area of the information carrier.

7. The information device according to claim 5, wherein the recording element and the reproducing element are arranged such that, when a recording operation or a reproducing operation is performed, the recording element reaches a position where information on the information carrier is recorded or reproduced and then the reproducing element reaches the position.

8. The information device according to claim 7, wherein the recording element and the reproducing element are arranged apart from each other by a distance equal to or larger than a distance determined on the basis of the number of revolutions of the information carrier and time from start to end of a change of a recording film of the information carrier at the time when the recording operation is performed.

9. The information device according to claim 5, further comprising a checking unit configured to reproduce, with the reproducing element, information recorded by the recording element in parallel to the recording operation to thereby check whether the recording by the recording element has been correctly performed.

10. The information device according to claim 5, wherein the recording element and the reproducing element are arranged such that, when a recording operation or a reproducing operation is performed, the reproducing element reaches a position where information on the information carrier is recorded or reproduced and then the recording element reaches the position.

11. The information device according to claim 10, wherein the recording element and the reproducing element are arranged apart from each other by a distance equal to or larger than a distance determined on the basis of the number of revolutions of the information carrier, and a total time of a reproduction delay time required for a reproducing signal to pass a reproducing signal transmission line through which the reproducing signal is transmitted, a circuit delay time required for processing the reproducing signal, and a recording delay time required for a recording signal to pass a recording signal transmission line through which the recording signal is transmitted.

12. The information device according to claim 10, further comprising an overwrite processing unit configured to record, with the recording element, information reproduced by the reproducing element in parallel to the reproducing operation to thereby overwrite information recorded on the information carrier.

13. The information device according to claim 12, further comprising:
a reproducing signal quality measuring unit configured to measure signal quality of a reproducing signal obtained when the information recorded on the information carrier is reproduced; and
a recording quality determining unit configured to reproduce, with the reproducing element, the information recorded on the information carrier, and determine recording quality of the information recorded on the information carrier on the basis of a measurement result from the reproducing signal quality measuring unit, wherein
when it is determined by the recording quality determining unit that the recording quality is poor, the overwrite processing unit records, with the recording element and in parallel to the reproducing operation, the information reproduced by the reproducing element in a position where the information is recorded on the information carrier to thereby overwrite the information recorded on the information carrier.

14. The information device according to claim 5, further comprising:
a recording track positional deviation detecting unit configured to detect a positional deviation between the recording element and the track; and
a reproducing track positional deviation detecting unit configured to detect a positional deviation between the reproducing element and the track.

15. The information device according to claim 5, further comprising:
a reproducing track positional deviation detecting unit configured to detect a positional deviation between the reproducing element and the track; and
a recording track positional deviation estimating unit configured to estimate a positional deviation between the recording element and the track on the basis of a signal from the reproducing track positional deviation detecting unit.

16. The information device according to claim 15, wherein the recording track positional deviation estimating unit estimates the positional deviation between the recording element and the track on the basis of a radial position of the information carrier where the head is located.

17. The information device according to claim 5, wherein
the head further includes an element for tracking arranged on a track same as the track of the recording element and near the recording element, and
the information device further comprises:
a recording track positional deviation detecting unit configured to detect a positional deviation between the element for tracking and the track; and
a reproducing track positional deviation detecting unit configured to detect a positional deviation between the reproducing element and the track.

18. The information device according to claim 5, further comprising:
a recording track positional deviation detecting unit configured to detect a positional deviation between the recording element and the track;
a recording abnormality detecting unit configured to detect whether an abnormality has occurred during a recording operation on the basis of a signal from the recording track positional deviation detecting unit during the recording operation; and
a following stopping unit configured to stop the reproducing element from following the target track when it is detected by the recording abnormality detecting unit that an abnormality has occurred during the recording operation.

19. The information device according to claim 1, wherein
the head further includes a magnetic recording element for magnetically recording information on the information carrier,
the first element includes an element for tracking,
the second element includes a heating element for heating a recording target area of the information carrier,
the element for tracking is arranged on a track same as the track of the magnetic recording element and near the magnetic recording element, and
the head moving unit and the inter-element distance varying unit cause the element for tracking and the heating element to follow a same track to thereby cause the magnetic recording element and the heating element to follow a same track.
